(19) United States
(12) Patent Application Publication
(10) Pub. No.: US 2025/0106693 A1
(43) Pub. Date: Mar. 27, 2025

(54) BACKSCATTER COMMUNICATION CONFIGURATION METHOD AND APPARATUS, NETWORK SIDE DEVICE, AND TERMINAL

(71) Applicant: VIVO MOBILE COMMUNICATION CO., LTD., Dongguan (CN)

(72) Inventors: Jiansheng CAI, Dongguan (CN); Kai WU, Dongguan (CN); Dongru LI, Dongguan (CN); Yong WANG, Dongguan (CN); Junjie TAN, Dongguan (CN)

(73) Assignee: VIVO MOBILE COMMUNICATION CO., LTD., Dongguan (CN)

(21) Appl. No.: 18/972,822

(22) Filed: Dec. 6, 2024

Related U.S. Application Data
(63) Continuation of application No. PCT/CN2023/098049, filed on Jun. 2, 2023.

(30) Foreign Application Priority Data
Jun. 9, 2022 (CN) 202210652034.3

(51) Int. Cl. H04W 28/18; G06K 7/10; G06K 19/07

(52) U.S. Cl. CPC H04W 28/18; G06K 7/10297; G06K 19/0723

(57) ABSTRACT

This application provides a backscatter communication configuration method and apparatus, a network side device, and a terminal. The backscatter communication configuration method includes: sending, by a network side device, first configuration information; and performing, by the network side device, backscatter communication based on the first configuration information. The first configuration information is used to indicate either of the following: a target communication mode of the backscatter communication; or the target communication mode and a first parameter. The first parameter is a related communication parameter corresponding to the target communication mode.

### CROSS-REFERENCE TO RELATED APPLICATIONS

This application is a continuation of International Application No. PCT/CN 2023/098049, filed on Jun. 2, 2023, which claims priority to Chinese Patent Application No. 202210652034.3 filed on Jun. 9, 2022. The entire contents of each of the above-referenced applications are expressly incorporated herein by reference.

### TECHNICAL FIELD

This application pertains to the field of communication technologies, and specifically, to a backscatter communication configuration method and apparatus, a network side device, and a terminal.

### BACKGROUND

Backscatter Communication (BSC) means that a backscatter communication device performs signal modulation by using a radio frequency signal in another device or an environment to transmit information of the backscatter communication device. A conventional backscatter communication system includes a reader and a tag, where the reader is configured to send a signal, and the tag is configured to reflect a signal.

In a related technology, in comparison with a conventional backscatter communication system, a new terminal is added to a backscatter communication system supported in 5^{th} Generation (5G) New Radio (NR), thereby generating a new communication scenario, so that there may be a plurality of options for signal transmission paths between a network side device, a terminal, and a backscatter device, signal sending time, and the like. Consequently, there may be a problem of inconsistent communication modes of backscatter transmission between the network side device, the terminal, and the backscatter device, reducing performance of backscatter communication.

### SUMMARY

Embodiments of this application provide a backscatter communication configuration method and apparatus, a network side device, and a terminal, so that the network side device can configure communication modes and related parameters of a terminal and/or a backscatter device, and therefore, the network side device, the terminal, and the backscatter device can perform backscatter communication based on consistent communication modes and related parameters, thereby improving performance of the backscatter communication.

According to a first aspect, a backscatter communication configuration method is provided, and the method includes:
sending, by a network side device, first configuration information; and
performing, by the network side device, backscatter communication based on the first configuration information; where
the first configuration information is used to indicate either of the following:
a target communication mode of the backscatter communication; or
the target communication mode and a first parameter, where the first parameter is a related communication parameter corresponding to the target communication mode.

According to a second aspect, a backscatter communication configuration apparatus is provided and applied to a network side device. The apparatus includes:
a first sending module, configured to send first configuration information; and
a first execution module, configured to perform backscatter communication based on the first configuration information; where
the first configuration information is used to indicate either of the following:
a target communication mode of the backscatter communication; and
the target communication mode and a first parameter, where the first parameter is a related communication parameter corresponding to the target communication mode.

According to a third aspect, a backscatter communication configuration method is provided, and the method includes:
receiving, by a backscatter device, first configuration information from a network side device or third configuration information from a terminal; and
performing, by the backscatter device, backscatter communication based on the first configuration information or the third configuration information, where
the first configuration information or the third configuration information indicates a transmission parameter of the backscatter device in a target communication mode.

According to a fourth aspect, a backscatter communication configuration apparatus is provided and applied to a backscatter device. The apparatus includes:
a first receiving module, configured to receive first configuration information from a network side device, or configured to receive third configuration information from a terminal; and
a second execution module, configured to perform backscatter communication based on the first configuration information or the third configuration information; where
the first configuration information or the third configuration information indicates a transmission parameter of the backscatter device in a target communication mode.

According to a fifth aspect, a backscatter communication configuration method is provided, and the method includes:
receiving, by a terminal, first configuration information; and
performing, by the terminal, backscatter communication based on the first configuration information; where
the first configuration information is used to indicate either of the following:
a target communication mode of the backscatter communication; or
the target communication mode and a first parameter, where the first parameter is a related communication parameter corresponding to the target communication mode.

According to a sixth aspect, a backscatter communication configuration apparatus is provided and applied to a terminal. The apparatus includes:
a second receiving module, configured to receive first configuration information; and
a third execution module, configured to perform backscatter communication based on the first configuration information; where
the first configuration information is used to indicate either of the following:
a target communication mode of the backscatter communication; and
the target communication mode and a first parameter, where the first parameter is a related communication parameter corresponding to the target communication mode.

According to a seventh aspect, a network side device is provided. The network side device includes a processor and a memory, the memory stores a program or an instruction that is capable of being run on the processor, and when the program or the instruction is executed by the processor, the steps of the method according to the first aspect are implemented.

According to an eighth aspect, a backscatter device is provided. The backscatter device includes a processor and a memory, the memory stores a program or an instruction that is capable of being run on the processor, and when the program or the instruction is executed by the processor, the steps of the method according to the third aspect are implemented.

According to a ninth aspect, a terminal is provided. The terminal includes a processor and a memory, the memory stores a program or an instruction that is capable of being run on the processor, and when the program or the instruction is executed by the processor, the steps of the method according to the fifth aspect are implemented.

According to a tenth aspect, a network side device is provided, including a processor and a communication interface. The communication interface is configured to send first configuration information and perform backscatter communication based on the first configuration information, where the first configuration information is used to indicate either of the following:
a target communication mode of the backscatter communication; and
the target communication mode and a first parameter, where the first parameter is a related communication parameter corresponding to the target communication mode.

According to an eleventh aspect, a terminal is provided, including a processor and a communication interface. The communication interface is configured to receive first configuration information and perform backscatter communication based on the first configuration information, where the first configuration information is used to indicate either of the following:
a target communication mode of the backscatter communication; and
the target communication mode and a first parameter, where the first parameter is a related communication parameter corresponding to the target communication mode.

According to a twelfth aspect, a wireless communication system is provided, including a terminal, a network side device, and a backscatter device. The network side device may be configured to perform the steps of the backscatter communication configuration method according to the first aspect. The backscatter device may be configured to perform the steps of the backscatter communication configuration method according to the third aspect. The terminal may be configured to perform the steps of the backscatter communication configuration method according to the fifth aspect.

According to a thirteenth aspect, a readable storage medium is provided. The readable storage medium stores a program or an instruction, and the program or the instruction is executed by a processor to implement the steps of the method according to the first aspect, the steps of the method according to the third aspect, or the steps of the method according to the fifth aspect.

According to a fourteenth aspect, a chip is provided. The chip includes a processor and a communication interface, the communication interface is coupled to the processor, and the processor is configured to run a program or an instruction to implement the method according to the first aspect, the method according to the third aspect, or the method according to the fifth aspect.

According to a fifteenth aspect, a computer program/program product is provided. The computer program/program product is stored in a storage medium, and the computer program/program product is executed by at least one processor to implement the steps of the backscatter communication configuration method according to the first aspect, the third aspect, or the fifth aspect.

In the embodiments of this application, a network side device may send first configuration information to a terminal and a backscatter device, so that the network side device, the terminal, and the backscatter device agree on a communication mode and a related parameter that are used for backscatter communication; or a network side device may send first configuration information to a terminal, and the terminal sends third configuration information to a backscatter device based on the first configuration information, and in this case, the terminal may determine a target communication mode and a related parameter of backscatter communication based on the first configuration information, and the backscatter device may determine the target communication mode and the related parameter of the backscatter communication based on the third configuration information. This can also enable the network side device, the terminal, and the backscatter device to agree on the communication mode and the related parameter that are used for the backscatter communication. In this way, after the network side device, the terminal, and the backscatter device agree on the communication mode and the related parameter that are used for the backscatter communication, the backscatter communication can be performed based on consistent communication modes and related parameters, thereby improving performance of the backscatter communication.

### BRIEF DESCRIPTION OF DRAWINGS

FIG. 1 is a schematic diagram of a structure of a wireless communication system to which embodiments of this application can be applied;

FIG. 2 is a schematic diagram of an interaction process between a tag and a reader;

FIG. 3 is a schematic diagram of a signal transmitted between a tag and a reader;

FIG. 4 is a schematic diagram of information transmission between a tag and a reader;

FIG. 5 is a schematic flowchart of data receiving and sending of a tag;

FIG. 6 is a schematic flowchart of querying and accessing a single tag;

FIG. 7 is a flowchart of a first type of backscatter communication configuration method according to an embodiment of this application;

FIG. 8a is a schematic diagram of a scenario in a second mode;

FIG. 8b is a first schematic diagram of a scenario in a first mode;

FIG. 8c is a second schematic diagram of a scenario in a first mode;

FIG. 8d is a third schematic diagram of a scenario in a first mode;

FIG. 9 is a flowchart of a second type of backscatter communication configuration method according to an embodiment of this application;

FIG. 10 is a flowchart of a third type of backscatter communication configuration method to an embodiment of this application;

FIG. 11a is a first schematic diagram of information exchange in a backscatter communication configuration method according to an embodiment of this application;

FIG. 11b is a second schematic diagram of information exchange in a backscatter communication configuration method according to an embodiment of this application;

FIG. 11c is a third schematic diagram of information exchange in a backscatter communication configuration method according to an embodiment of this application;

FIG. 11d is a fourth schematic diagram of information exchange in a backscatter communication configuration method according to an embodiment of this application;

FIG. 12 is a schematic diagram of a structure of a first type of backscatter communication configuration apparatus according to an embodiment of this application;

FIG. 13 is a schematic diagram of a structure of a second type of backscatter communication configuration apparatus according to an embodiment of this application;

FIG. 14 is a schematic diagram of a structure of a third type of backscatter communication configuration apparatus according to an embodiment of this application;

FIG. 15 is a schematic diagram of a structure of a communication device according to an embodiment of this application;

FIG. 16 is a schematic diagram of a structure of a terminal according to an embodiment of this application; and

FIG. 17 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

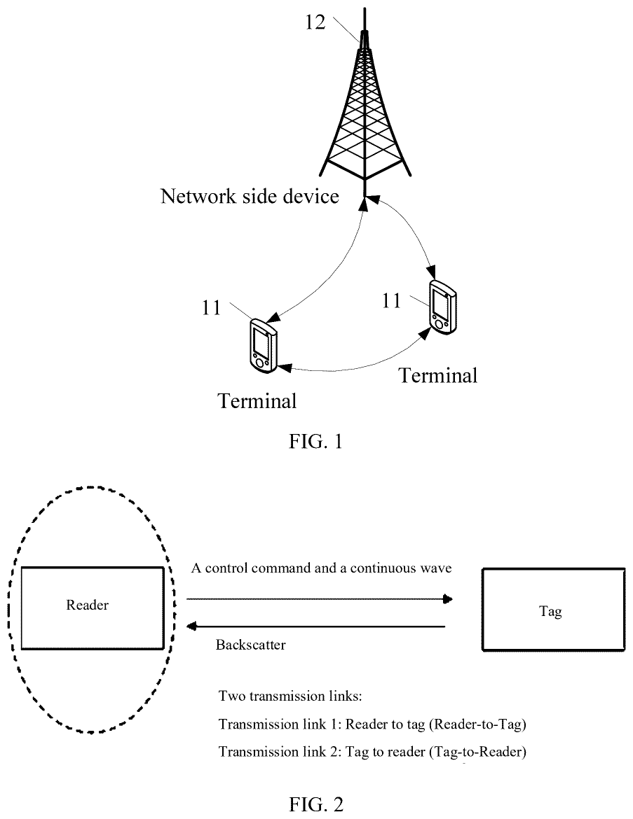

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer that is also referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wireless Fidelity (WiFi) node, or the like. The base station may be referred to as a NodeB, an Evolved Node B (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application service discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that, in the embodiments of this application, only a core network device in the NR system is used as an example for description, and a specific type of the core network device is not limited.

Backscatter communication BSC means that a backscatter communication device performs signal modulation by using a radio frequency signal in another device or an environment to transmit information. The backscatter communication device may be:
(1) a backscatter communication device in a conventional radio frequency identification (RFID) technology, which is usually a tag, and is a passive Internet of Things (IoT) device (that is, Passive-IoT);
(2) a semi-passive tag, where downlink reception or uplink reflection of such a tag has a specific amplification capability; or
(3) a tag (active tag) with an active sending capability, where such a tag may send information to a reader without relying on reflection of an incident signal.

For example, as shown in FIG. 2, a passive tag is used as an example, a reader may send a control command and a continuous wave (CW) signal to the tag, and the tag may perform an operation according to the control command and use the continuous wave signal as an excitation source to perform backscattering, to feed back information to the reader.

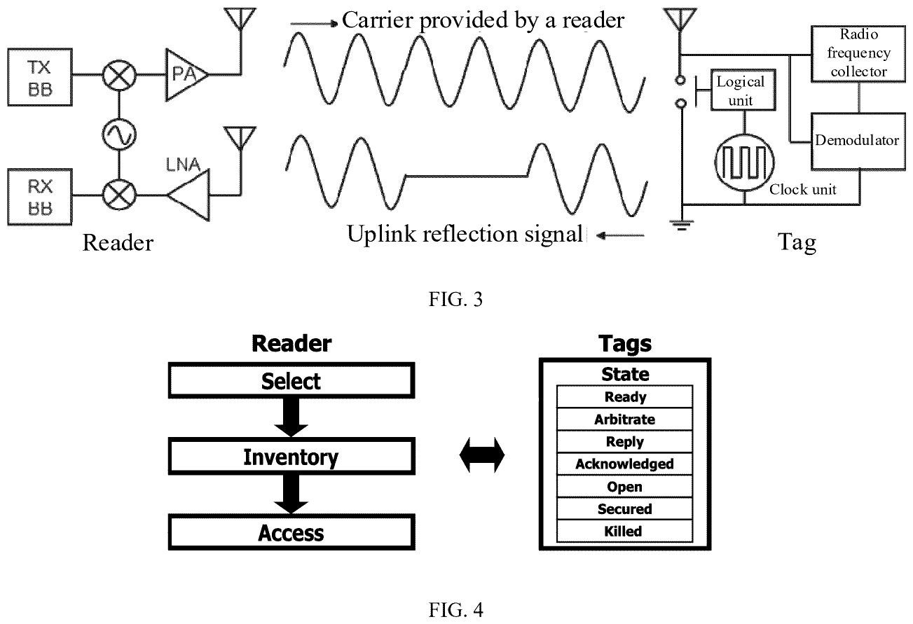

A simple implementation in which the tag feeds back information is: As shown in FIG. 3, when the tag needs to send ‘1’, the tag reflects an incident carrier signal, and when the tag needs to send ‘0’, the tag does not perform reflection. In this case, the reader can obtain feedback information of the tag by comparing a received reflected signal with a transmitted signal.

In some embodiments, a backscatter communication device controls a reflection coefficient Γ of a circuit by adjusting internal impedance of the backscatter communication device, to change an amplitude, a frequency, a phase, and the like of an incident signal, thereby implementing signal modulation. A reflection coefficient of a signal may be represented as:

$$Γ = \frac{{Z}_{1} - {Z}_{0}}{{Z}_{1} + {Z}_{0}} = \vert Γ \vert {e}^{j {θ}_{T}}$$

Z₀ is antenna characteristic impedance, and Z₁ is load impedance. It is assumed that the incident signal is Sᵢₙ(t). In this case, an output signal is Sₒᵤₜ(t)=Sᵢₙ(t)|Γ|e^{jθ}^{_{T}}. Therefore, corresponding amplitude modulation, frequency modulation, or phase modulation can be implemented through proper control of the reflection coefficient.

In addition, as shown in FIG. 4, the foregoing reader may exchange information with the tag, to control the tag as follows:
(1) Select: The reader selects a tag population for subsequent inventory or challenges a tag population in an encrypted manner, to perform a subsequent identity authentication process. Select control includes: a select command and a challenge command.
(2) Inventory: A process in which the reader identifies the tag. The reader transmits a query command in one of four sessions to start a round of inventory. There may be one or more tag pairs to respond to the query command. If the reader detects a response of a single tag, the reader may request a protocol control word (PC), an optional extended protocol control word (XPC), an electronic product code (EPC), and 16-bit cyclic redundancy check code (CRC-16) from the tag. Only one round of inventory operation can be performed in one session at a time, and one round of inventory may include a plurality of control commands.
(3) Access: A process in which the reader interacts with a single tag (for example, read, write, verify, or interact in another manner). The reader individually and uniquely identifies the tag before accessing. Access includes a plurality of commands.

A command for operating the tag by the reader may carry an inventory round (Inventory round), a Q value, and a slot. Definitions thereof are shown in the following Table 1:

TABLE 1

| | |
|---|---|
| Inventory | A round that is started by a query command and terminated by a subsequent |
| round | query command (which also starts a new round of inventory), select |
| | command, or challenge command. |
| Q | A parameter used by a reader to adjust a response probability of a tag. The |
| | reader instructs the tag in the inventory round to load a Q-bit random (or |
| | pseudo-random) number into a slot counter of the tag. The reader may also |
| | order the tag to reduce slot counters of the tag. When a value (that is, a slot |
| | of the tag - refer to the following descriptions) of the slot counter in the tag is |
| | zero, the tag will make a reply. Q is an integer in a range (0, 15). A |
| | corresponding response probability range of the tag is 2⁰ = 1 to |
| | 1/2¹⁵ = 0.000031. In other words, a tag population in one round of inventory |
| | may be controlled through adjustment of the Q value. |
| Slot | The slot corresponds to a point in the inventory round to which the tag may |
| | respond. The slot is a value output by the slot counter of the tag. The tag |
| | makes a reply when the slot of the tag (that is, the value in the slot counter) is |
| | zero. |
| | In other words, the slot refers to a value that is randomly selected by the tag |
| | from 0 to 2^{Q} − 1 based on the Q value. Only a tag that selects a specific slot |
| | value, such as slot = 0, can further receive a control command in a next step. |

An operation type of the reader for the tag, that is, the control command, is shown in the following Table 2:

TABLE 2

| Operation | | |
|---|---|---|
| type | Command | Function |
| Select | Select | Select a tag. The select command allows the reader to |
| | | select a tag population for subsequent inventory. |
| | Challenge | The challenge command allows the reader to challenge the |
| | | tag population for subsequent identity authentication. |
| Inventory | Query | Start inventory once |
| | | The query command is used to start a round of inventory |
| | | and determine which tags participate in this round of |
| | | inventory. |
| | | The query command includes a slot counting parameter Q. |
| | | After the query command is received, a tag that |
| | | participates in inventory separately selects a random |
| | | number from a range (0, 2^{Q} − 1) and load the value into a |
| | | slot counter of the tag. If the tag selects a zero value, the |
| | | tag switches to a responding state and makes a response |
| | | immediately. If the tag selects a non-zero value, the tag |
| | | switches to an arbitrate state and waits for a query adjust |
| | | (QueryAdjust) command or a query repeat (QueryRep) |
| | | command. |
| | Query adjust | Used to control the tag to adjust a quantity of original |
| | | slots. |
| | Query repeat | Used to control the tag to reduce the number of slots of the |
| | (QueryRep) | tag. |
| | EPC | A command that is responded by the reader to the tag. The |
| | acknowledgment | tag will backscatter an RN16 reply signal. |
| | (ACK) | |
| | Switch negative | A command sent by the reader. |
| | acknowledgement | Used to control the tag to return to an arbitrate state |
| | (NAK) | At any time, the reader can issue a NAK command. All |
| | | tags that receive the NAK in the current round of inventory |
| | | correspond to the NAK command and return the arbitrate |
| | | state without changing an inventory flag. |
| Access | Random request | Used to request the tag to generate a random number. |
| | (Req_RN) | |
| | Read | Used to read data from a location in storage of the tag. |
| | Write | Used to write data into storage of the tag. |
| | Kill | Used to control the tag not to make a response to any |
| | | reader, thereby preventing privacy leakage. After the tag is |
| | | killed, the tag is no longer available. |
| | Lock | Used to control the tag not to perform a write action any |
| | | longer, thereby preventing data from being tampered with |
| | | randomly. |
| | Access (an | When the tag has a password, the tag is made to switch |
| | optional | from an open state to a secure state. |
| | command) | |
| | Block write | A plurality of blocks are written at a time. |
| | (BlockWrite) (an | |
| | optional | |
| | command) | |
| | Lock erase (an | A plurality of blocks are erased from storage of a single |
| | optional | tag. |
| | command) | |
| | Authenticate | Security-related access command |
| | Secure command | The authenticate command may implement verification of |
| | (SecureComm) | the tag and the reader and/or mutual authentication of the |
| | Authentication | tag and the reader, depending on an implementation by the |
| | command | tag for encrypted information specified in the command |
| | (AuthComm) | for channel state information (Channel State Information, |
| | Key update | CSI). |
| | (KeyUpdate) | The AuthComm command allows authenticated reader to |
| | Tag privilege | tag communication. |
| | (TagPrivilege) | The SecureComm command allows secure reader to tag |
| | | communication. |
| | | The KeyUpdate command allows authenticated writing of |
| | | a querier or change of keys. |
| | | The TagPrivilege command allows the querier to |
| | | separately read or modify privileges of accessing a |
| | | password or a key. |
| | File open | Access-related commands for file management. |
| | (FileOpen). | File management access commands include FileOpen, |
| | File list | FileList, FileSetup, and FilePrivilege. |
| | File privilege | The FileOpen command allows a query program to open a |
| | (FilePrivilege) | file. |
| | File setup | The FileList command allows the query program to |
| | (FileSetup) | determine the existence, sizes, attributes, and privileges of |
| | | one or more files. |
| | | The FileSetup command allows the querier to change a file |
| | | type of a currently opened file and/or adjust a size of the |
| | | file. |
| | | The FilePrivilege command allows the querier to read or |
| | | change a privilege granted to the currently opened file (see |
| | | the following descriptions) to an open state or access a |
| | | password or a key. |
| | Req_RN, | Core access commands include a random number request |
| | Read | (Req_RN), read, write, lock, kill, access, block write |
| | Write | (BlockWrite), block erase (BlockErase), block domain |
| | Lock | lock (BlockPermalock), and untraceable. |
| | Kill | The Req_RN, Read, Write, Lock, and Kill commands are |
| | Access | mandatory. The Access, BlockWrite, BlockErase, |
| | Block Write | BlockPermalock, and Untraceable commands are optional. |
| | BlockErase | During implementation, the tag may receive one or more |
| | Block domain | optional commands, regardless of whether the tag supports |
| | lock | encryption security or file management. |
| | (BlockPermalock) | The Write, BlockWrite, and BlockErase commands allow |
| | Untraceable | the reader to write or erase a part of a memory of the tag. |
| | | The Lock and BlockPermalock commands allow the |
| | | reader to configure a part of the memory of the tag as |
| | | changeable, permanently-writable, or non-writable. |
| | | The Untraceable command allows the reader to have an |
| | | asserted untraceable privilege. |

However, the tag may be in any one of the following states in Table 3:

TABLE 3

| Tag state | Description |
|---|---|
| Ready | Not in a current inventory operation |
| Arbitrate | This tag is currently in a specific inventory operation |
| | Indicating that a value of a practice counter is not zero, that is, the |
| | counter is still waiting. |
| Reply | A 16-bit random number is generated to the reader. |
| | A state in which acknowledgment is performed when one ACK message |
| | is received. |
| | Return to an arbitrate state when no ACK message is received. |
| Acknowledge | Enter any state other than a killed state from this state. |
| Open | A state that a tag whose password is not zero is in when receiving a |
| | command of a random request in an acknowledgment state. |
| Secure | A state that a tag whose password is zero is in when receiving, in the |
| | acknowledgment state, a command of a random request sent by the |
| | reader. |
| Killed | A state of being permanently unavailable. |

In a related technology, a protocol of an ultra high frequency (UHF) RFID is designed in an inventory mode, and a reader is required to send a query command (Query), and then a tag responds with a reply, that is, generates a 16-bit random number to a reader. Then, after the reader sends this sequence to the tag by using an ACK command, the tag sends related data to the reader.

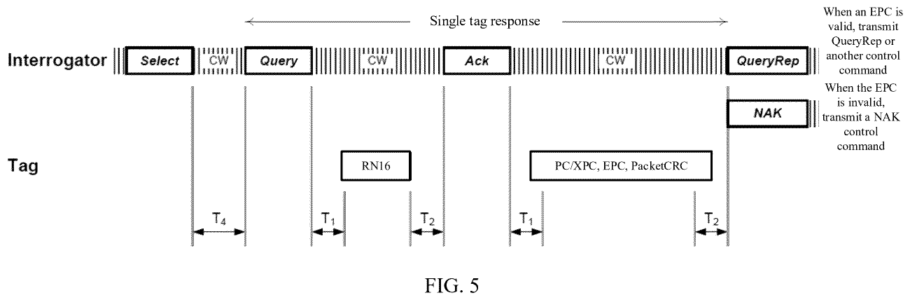

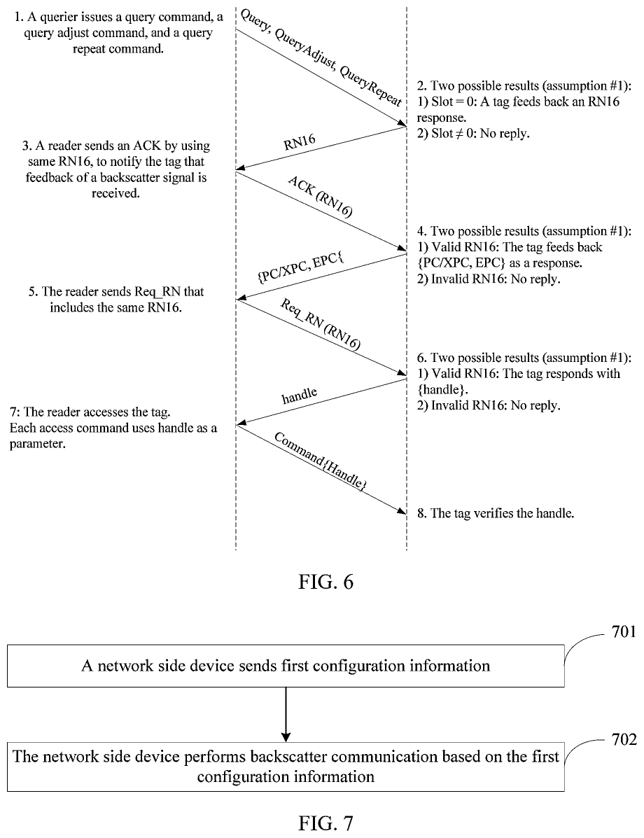

For example, as shown in FIG. 5 and FIG. 6, a process in which a reader performs data interaction with a tag mainly includes the following steps:
Step 1: The reader sends a Query command, a QueryAdjust command, and a QueryRep command.
Step 2: There are two possible results (assuming that a result shown in an embodiment shown in FIG. 6 is a first result):
(1) Slot=0: The tag feeds back RN16 as a reply.
(2) Slot≠0: No reply.
Step 3: The reader sends an ACK by using a same RN16, to notify the tag that backscatter signal feedback is received.
Step 4: There are two possible results (assuming that a result shown in an embodiment shown in FIG. 6 is a first result):
(1) Valid RN16: The tag feeds back {PC/XPC, EPC} as a response.
(2) Invalid RN16: No reply.
Step 5: The reader sends a Req_RN command that includes the same RN16.
Step 6: There are two possible results (assuming that a result shown in an embodiment shown in FIG. 6 is a first result):
(1) Valid RN16: The tag feeds back {handle} as a response.
(2) Invalid RN16: No reply.
Step 7: The reader accesses the tag. Each access command uses handle as a parameter.
Step 8: The tag verifies the handle.

It should be noted that, in the accompanying drawing shown in FIG. 6, an interaction process of CRC-16 is omitted. For meanings of the commands in the embodiment shown in FIG. 6, refer to Table 1 to Table 3. Details are not described herein again.

In a related technology, in comparison with a conventional backscatter communication system, a new terminal is added to a backscatter communication system supported in 5G New Radio (NR), thereby generating a new communication scenario, so that there may be at least two options for signal transmission paths between a network side device, a terminal, and a backscatter device, signal sending time, and the like. According to the backscatter communication configuration method provided in the embodiments of this application, in a backscatter communication scenario in which a terminal participates, different backscatter communication modes and communication parameters required in different communication modes are configured by using a network side device, so that communication modes and related parameters that are used by the network side device, the terminal, and a backscatter device in backscatter communication are consistent. In this way, backscatter communication can be performed based on consistent communication modes and related parameters, thereby improving performance of the backscatter communication.

A backscatter communication configuration method and apparatus, a network side device, a terminal, and a backscatter device provided in the embodiments of this application are described below with reference to the accompanying drawings by using some embodiments and application scenarios thereof.

Referring to FIG. 7, a first type of backscatter communication configuration method provided in an embodiment of this application may be performed by a network side device. The network side device may be various network side devices 12 listed in the embodiment shown in FIG. 1. For ease of description, in this embodiment of this application, a base station is used as an example of the network side device for description. This is not specifically limited herein.

As shown in FIG. 7, the backscatter communication configuration method performed by the network side device may include the following steps:
Step 701: The network side device sends first configuration information, where the first configuration information is used to indicate either of the following:
a target communication mode of backscatter communication; and
the target communication mode and a first parameter, where the first parameter is a related communication parameter corresponding to the target communication mode.

During implementation, the network side device may send the first configuration information to at least one of a terminal and a backscatter device (assumed as a tag). Configuration information sent to the tag may be carried in a control command, and configuration information sent to the terminal may be carried in a signal such as radio resource control (RRC) signaling, system information, a medium access control control element (MAC CE), or downlink control information (DCI).

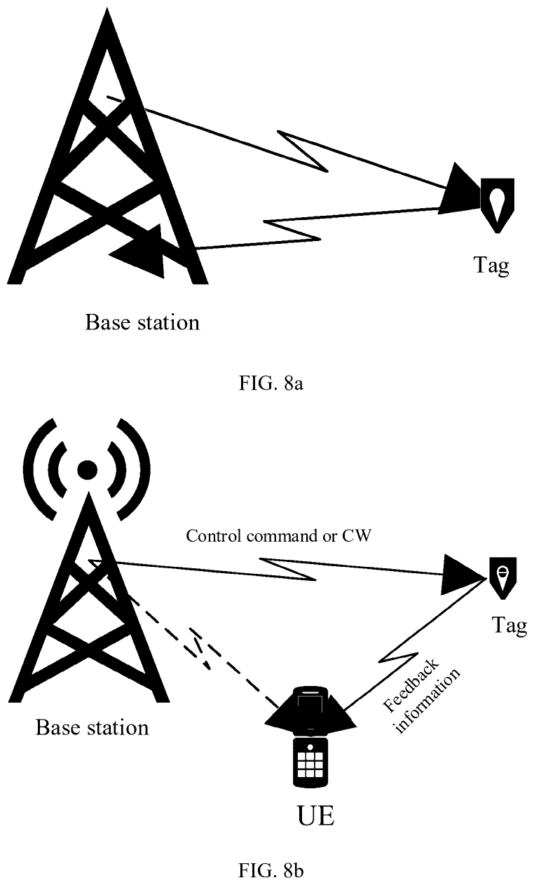

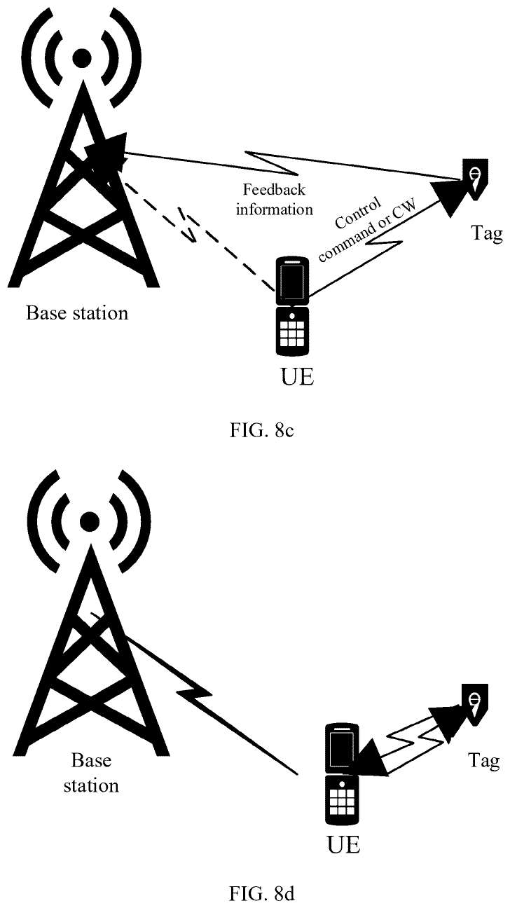

For example, in a scenario of cellular backscatter with no user equipment (UE) assistance shown in FIG. 8a, a base station may directly perform backscatter communication with the tag. In this case, the base station may send the first configuration information to the tag, so that both the base station and the tag perform backscatter communication in a second mode, where in the second mode, the base station directly performs backscatter communication with the tag without a need to perform the backscatter communication with assistance of the terminal.

For example, in a scenario of cellular backscatter with UE assistance shown in FIG. 8b, FIG. 8c, and FIG. 8d, the base station may send the first configuration information to the tag and the UE, so that the base station, the UE, and the tag all perform backscatter communication in a first mode, where in the first mode, the UE can assist the base station in performing the backscatter communication with the tag. For example, the UE shown in FIG. 8b assists the base station in receiving feedback information from the tag, and/or the UE shown in FIG. 8c assists the base station in sending a continuous wave CW signal and/or a control instruction to the tag, and/or the UE shown in FIG. 8d assists the base station in sending a CW to the tag and receiving feedback information from the tag, and the UE further sends a second control command (ACK/NACK) to the tag based on the received feedback information of the tag.

It should be noted that during implementation, in a case that the terminal serves as a receive end of the feedback information, the terminal may sort out the received feedback information of the tag to obtain first information, and report the first information to the base station, so that the base station sends a second control command (ACK/NACK) to the tag based on the first information.

In addition, during actual application, in the scenario of cellular backscatter with UE assistance shown in FIG. 8b, FIG. 8c, and FIG. 8d, the base station may send the first configuration information to the UE, and the UE sends corresponding third configuration information to the tag based on the first configuration information. For example, the network side device may configure, for the terminal, related information of a control command that carries the third configuration information, so that the terminal sends, to the tag, the control command that carries the third configuration information. In this way, the base station, the UE, and the tag may also implement backscatter communication in the first mode. This is not specifically limited herein.
Step 702: The network side device performs backscatter communication based on the first configuration information.

During implementation, that the network side device performs backscatter communication based on the first configuration information may be: In a case that the target communication mode of the backscatter communication that is indicated by the first configuration information is the first mode, the terminal assists in performing the backscatter communication. In a case that the target communication mode of the backscatter communication that is indicated by the first configuration information is the second mode, the backscatter communication may be performed with the backscatter device without assistance of the terminal. In other words, in the second mode, the network side device directly performs the backscatter communication with the backscatter device.

During implementation, the first parameter may include a communication parameter that is required to control at least one of the network side device, the backscatter device, and the terminal to work in the target communication mode. For example, the first parameter may indicate whether an execution device of a function (sending a first signal, sending a control command, receiving feedback information, and the like) is the terminal or the base station, and indicate an execution time point of a function. In this way, in a process of performing the backscatter communication, the network side device, the backscatter device, and the terminal can clearly learn functions that need to be performed by the network side device, the backscatter device, and the terminal, an order of performing the functions, and the like. Therefore, performance of the backscatter communication can be improved.

In an optional implementation, in a case that the target communication mode is the first mode, the first parameter includes at least one of the following:
first indication information, where the first indication information is used to indicate a transmit end of a first signal, the first signal is an excitation source of the backscatter device, and the transmit end of the first signal includes the network side device or the terminal;
second indication information, where the second indication information is used to indicate a transmit end of a control command, the control command is used to control the backscatter device, and the transmit end of the control command includes the network side device or the terminal; and
third indication information, where the third indication information is used to indicate a receive end of feedback information in the backscatter communication, the feedback information corresponds to the control command, the backscatter device obtains, based on the first signal, an excitation source that sends the feedback information, and the receive end of the feedback information includes the network side device or the terminal.

Option 1: The first indication information may indicate whether a device that sends the first signal is the network side device or the terminal. The first signal may be any signal that can provide an excitation source for the backscatter device. For ease of description, in this embodiment of this application, as an example for description, the first signal is a continuous wave CW signal. This does not constitute a specific limitation herein.

Option 2: The second indication information may indicate whether a device that sends the control command to the backscatter device is the network side device or the terminal. The control command may include at least one of the following:
a first control command, where the first control command includes at least one of a select command, a challenge command, and an access command; and
a second control command, where the second control command is a feedback command corresponding to the feedback information.

The select command may include a select command, a challenge command, and a sort command. The challenge command includes a query command, a QueryAdjust command, and a QueryRep command. The access command includes a Req_RN command, a read command, a write command, a lock command, a kill command, an access command, a BlockWrite command, a BlockErase command, a BlockPermalock command, an authenticate command, a ReadBuffer command, a SecureComm command, an AuthComm command, a KeyUpdate command, an Untraceable command, a FileOpen command, a FileList command, a FilePrivilege command, a FileSetup command, and a TagPrivilege command.

For meanings of the foregoing control commands, refer to descriptions in Table 2. Details are not described herein again.

During implementation, a backscatter device that receives the first control command may perform a corresponding operation, and feed back an execution result or a query result of the first control command based on the excitation source of the first signal. For ease of description, information fed back by the backscatter device after the first control command is executed is referred to as feedback information. A receive end of the feedback information may be indicated by third indication information as the network side device or the terminal. In this case, the network side device or the terminal may further make a reception response to the feedback information, that is, send the second control command to the backscatter device, so as to notify the backscatter device whether the feedback information fed back by the backscatter device is received. The second control command may include an ACK command and a NACK command. For example, if the network side device serves as a receive end of the feedback information and a transmit end of the second control command, in a case that the network side device receives feedback information of a tag, the network side device may send an acknowledgement (ACK) command to the tag, to notify the tag that feedback information sent by the tag is correctly received; and in a case that the network side device does not receive the feedback information of the tag within preset duration after sending the first control command to the tag, the network side device may send a negative acknowledgement (NACK) command to the tag, to notify the tag that the feedback information sent by the tag is not correctly received, so that the tag determines whether the first control command needs to be re-executed and/or whether the feedback information need to be re-sent.

During implementation, the first control command and the second control command may be sent by a same device or different devices. For example, both the first control command and the second control command are sent by the network side device, and the terminal is responsible for receiving feedback information from the tag and sending, to the network side device, first information obtained through sorting based on the feedback information; or both the first control command and the second control command are sent by the terminal; or the network side device sends the first control command, and the terminal receives the feedback information and sends the second control command; or the terminal sends the first control command, and the network side device receives the feedback information and sends the second control command. Examples are not exhausted herein.

Option 3: The third indication information may indicate whether a device that receives the feedback information sent by the backscatter device is the network side device or the terminal.

In some embodiments, in a case that the receive end of the feedback information that is indicated by the third indication information is different from a processing end of the feedback information, the third indication information is further used to instruct the receive end of the feedback information to send first information to the processing end of the feedback information, where the first information includes feedback information of a first device that is received by the receive end of the feedback information, and the first device includes at least a part of the backscatter device that receives the control command.

During implementation, the processing end of the feedback information may be a transmit end of the second control command, and the transmit end of the second control command needs to determine, based on the obtained feedback information, which backscatter devices to which the second control command is to be sent, and determine whether to send an ACK command or a NACK command.

In this implementation, if the receive end of the feedback information and the transmit end of the second control command are not a same device, the receive end of the feedback information may send first information to the transmit end of the second control command according to the third indication information, where the first information may include feedback information received by the receive end of the feedback information.

It should be noted that, in actual application, the first device may be at least a part, of the backscatter device that receives the first control command, that executes the first control command and feeds back the feedback information.

During implementation, a competitive communication process is used between a plurality of tags in a backscatter communication system:

In a backscatter communication system in a related technology, a reader can usually receive a backscatter signal of only one tag at a same moment. For example, in an inventory procedure of an RFID, when the reader sends a control command to enable an inventory procedure for a plurality of tags, a value Q is indicated. Each tag locally selects a value q from {0, . . . , 2^{Q}−1} at random. A tag whose current random value is 0 transmits a backscatter signal in response to the control command of the reader. A tag whose current random value is not 0 temporarily does not transmit a backscatter signal. After completing communication with the tag whose random value is 0, the reader may continue to send a control command (for example, a QueryRep command), for example, to instruct tag to decrease a generated random number by 1. A tag whose random number is reduced to 0 performs backscatter transmission in response to the control command. In this case, the first device may include a tag that performs backscatter transmission within preset time (for example, a time interval configured by the network side device by using the first parameter).

The foregoing procedure is a random multiple access procedure, and there is a possibility that a plurality of tags locally generate a same random number, which leads to a possibility that a plurality of tags simultaneously perform backscatter transmission at a specific moment. In this case, the reader is probably unable to detect a backscatter signal of any tag, and does not receive a feedback for a backscatter signal from the tag. In this case, these tags continue to receive the control command from the reader, waiting for new opportunities for backscatter transmission. Therefore, when sending the control command, the reader should select a proper Q value and adjust the Q value gradually during inventory to reduce a collision probability in a process of communication with a plurality of tags. This also means that time for completing communication with the plurality of tags is prolonged.

In this implementation, behavior of the terminal and the network side device in backscatter communication may be indicated by using at least one of the first indication information, the second indication information, and the third indication information.

It should be noted that the control command and the first signal do not overlap in time domain. Generally, the first signal may be sent after a sending moment of each control command, so that after receiving and executing the control command, the tag can use the first signal as an excitation source for backscattering.

In some embodiments, in a case that the third indication information is further used to instruct the terminal to send the first information to the network side device, the first parameter further includes:
second configuration information, where the second configuration information is used to configure a first transmission parameter, and the first transmission parameter is a transmission parameter used when the network side device receives the first information.

The second configuration information may be the transmission parameter used when the network side device receives the first information, that is, a transmission parameter used when the terminal sends the first information, for example, a format of transmitting the first information, a physical channel mapping manner, a physical channel resource, and a transmission manner (for example, each time the terminal receives feedback information of one tag, the terminal reports the feedback information to the network side device immediately, or the terminal sorts feedback information of all tags that is received in a preset time period into the first information, and then reports the first information to the network side device).

During implementation, the second configuration information may be carried in RRC signaling, a MAC CE, or a DCI command. Details are not described herein again. In some embodiments, a plurality of groups of second configuration information and identification information (for example, number) of each group of second configuration information may be agreed upon in advance. Each group of second configuration information includes corresponding sending content, a format, a physical channel mapping manner, a physical channel resource, and the like. When configuring the transmission parameter used by the terminal to send the first information, the network side device may indicate identification information of a specific piece of second configuration information to the terminal.

In this implementation, the network side device may further configure a transmission parameter for reporting the first information by the terminal, so that transmission performance of the first information is more reliable.

In an optional implementation, in a case that the second indication information indicates that the transmit end of the control command is the network side device, that the network side device performs backscatter communication based on the first configuration information includes:
the network side device sends the first control command to the backscatter device; and
the network side device receives feedback information from the backscatter device, or the network side device receives first information from the terminal, where the first information is feedback information of at least a part of the backscatter device.

In this implementation, the network side device serves as the transmit end of the control command, and in backscatter communication, the network side device sends the first control command to the backscatter device.

In an optional implementation, in a case that the second indication information indicates that the transmit end of the control command is the network side device, that the network side device performs backscatter communication based on the first configuration information includes:
the network side device receives feedback information from a first device, or the network side device receives first information from the terminal, where the first device includes at least a part of the backscatter device that receives the first control command, and the first information includes feedback information of the first device that is received by the terminal; and
the network side device sends the second control command to the first device.

In this implementation, the network side device serves as the transmit end of the control command. In backscatter communication, after obtaining the feedback information of the first device, the network side device sends the second control command to the transmit end (the backscatter device) of the feedback information, to notify the transmit end (the backscatter device) of the feedback information by using the second control command that the feedback information of the backscatter device is successfully received. In this way, a backscatter device that does not receive the second control command may determine, based on that the second control command is not received, that feedback information of the backscatter device is not successfully received by the network side device, so that the first control command can be re-executed and/or the feedback information can be re-sent. This is not specifically limited herein.

It should be noted that, in actual application, if the transmit end of the second control command is the terminal, the terminal may send the second control command based on the feedback information after receiving the feedback information from the backscatter device. In this case, the terminal may not send the first information to the network side device. Even, in a case that the receive end of the feedback information is the network side device, the network side device may further send the first information to the terminal. Details are not described herein again.

In an optional implementation, in a case that the target communication mode is the second mode, that the network side device performs backscatter communication based on the first configuration information includes:
the network side device sends a first control command to the backscatter device, where the first control command includes at least one of a select command, a challenge command, and an access command;
the network side device receives feedback information of a first device, where the first device includes at least a part of the backscatter device; and
the network side device sends a second control command to the first device, where the second control command is a feedback command corresponding to the feedback information.

In this implementation, in the second mode, the network side device can perform backscatter communication without assistance of the terminal. However, in a process of performing backscatter communication, the network side device may still forward information between the network side device and the backscatter device by using a forwarding device (for example, the terminal).

In some embodiments, in a case that the target communication mode is the second mode, the first parameter includes at least one of the following:
fourth indication information, where the fourth indication information is used to indicate forwarding information of the backscatter communication.

The fourth indication information may be used to indicate either of the following:
the network side device directly performs the backscatter communication with the backscatter device, and in this case, no another device participates in the backscatter communication; and
the network side device performs the backscatter communication with the backscatter device by using a forwarding device, and in this case, the forwarding device may forward interaction information between the network side device and the backscatter device (for example, the forwarding device forwards feedback information fed back by the backscatter device to the network side device).

In this implementation, the fourth indication information may be used to indicate whether the forwarding device and the tag need to forward interaction between the network side device and the tag.

In some embodiments, the feedback information includes at least one of the following:
a temporary identifier (such as RN8, RN16, or handle) of the backscatter device, a quantity of inventory rounds, a protocol control word PC, an extended protocol control word XPC, and an electronic product code EPC.
(1) A backscatter device that sends the feedback information may be identified by using the temporary identifier.
(2) By using the quantity of inventory rounds, it may be identified which round of inventory that the feedback information is for.
(3) By using the protocol control word PC, the extended protocol control word XPC, and the electronic product code EPC, device information or commodity information attached to the backscatter device may be identified.

In some embodiments, the first parameter further includes at least one of the following:
a transmission parameter of the backscatter device, where the transmission parameter includes at least one of the following: a coding scheme, a modulation frequency, a data rate, and a Q value, and the Q value is used to control a response probability of the backscatter device;
a quantity N of rounds of inventory, where N is a positive integer;
a quantity M of backscatter devices in each round of inventory, where M is a positive integer;
a target timeline, where the target timeline includes time information of at least one signal transmission node in the backscatter communication; and
target resource information, where the target resource information includes time domain and/or frequency domain resource information of at least one transmission in the backscatter communication.

Option 1: The transmission parameter of the backscatter device may be used to control a transmission parameter used when the backscatter device sends the feedback information to the receive end of the feedback information. Definitions of the coding scheme, the modulation frequency, the data rate, and the Q value are the same as definitions of the coding scheme, the modulation frequency, the data rate, and the Q value in the backscatter communication in the related technology. Details are not described herein again.

Option 2: The quantity N of rounds of inventory may be used to indicate that the transmit end of the control command initiates N rounds of inventory (query), where N may be greater than or equal to 1.

In some embodiments, in a case that the first parameter includes the quantity N of rounds of inventory and N is greater than 1, a control command used to control the backscatter device includes an inventory round identifier, the inventory round identifier indicates that the control command is used for an n^{th} round of inventory, and n is a positive integer less than or equal to N.

In this implementation, each time a transmit end of the control command performs inventory of tags, an inventory identifier may be carried in the inventory command, to indicate a current round of inventory.

In actual application, a current round of inventory may be, for example, reflected by using the target timeline. Details are not described herein again.

Option 3: The quantity M of backscatter devices in each round of inventory may indicate that each inventory command can trigger an inventory procedure of M tags. During implementation, different N values may correspond to a same M value or different M values.

N and M may be mutually independent. In actual backscatter communication, only one of N and M may be configured. For example, if N is not configured, only one round of inventory is performed by default.

In actual application, N and M may be explicitly indicated, or N and M respectively corresponding to the first mode and the second mode may be predefined. In a case that the network side device indicates that the target communication mode of the backscatter communication is the first mode or the second mode, values of M and/or N in the target communication mode may be implicitly determined.

In a case that N and M are configured, the receive end of the feedback information can receive feedback information of a maximum of N*M tags. In this case, if the receive end of the feedback information is different from the transmit end of the second control command, the first information sent by the receive end of the feedback information to the transmit end of the second control command may include feedback information of a maximum of N*M tags.

Option 4: The target timeline may include time information of at least one signal transmission node in the backscatter communication, for example, sending time of the control command, sending time of the first signal, sending time of the first information, and sending time of the feedback information.

During implementation, at least one of the foregoing time information may be explicitly indicated by the network side device, or the first mode and the second mode may be associated with respective time information in advance. In this way, when the network side device indicates the target communication mode, the target timeline may be determined based on the time information associated with the target communication mode. An inventory procedure is used as an example. In different communication modes, inventory procedures are different from each other. Therefore, the network side device may configure, for different communication modes, time information that matches the inventory procedure.

For example, in the first mode assisted by UE, the target timeline may include sending time of the first information, sending time of a command, sending time of a CW, and time at which the tag feeds back information. In the second mode not assisted by UE, the target timeline may include time at which the network side device sends the CW and the command and time at which the tag feeds back information.

In some embodiments, the time information includes at least one of the following:
a first time interval, where a sending moment of the first signal is located in the first time interval, a start time point of the first time interval is an end moment of a first time unit, the first time unit is a time unit that sends a 1^{st} first control command to the backscatter device, and the first signal is used as an excitation source of the backscatter device;
a second time interval, where a time interval for sending two adjacent first control commands is greater than or equal to the second time interval;
a third time interval, where in a case that the target communication mode is a first communication mode, a sending moment of the first information is located in the third time interval, a start time point of the third time interval is a start/end moment of the first time unit, the first information includes feedback information of the first device, and the first device includes at least a part of the backscatter device that receives the first control command; and
a fourth time interval, where a time interval between a moment at which a same backscatter device receives the first control command and a moment at which the feedback information is sent is less than or equal to the fourth time interval.

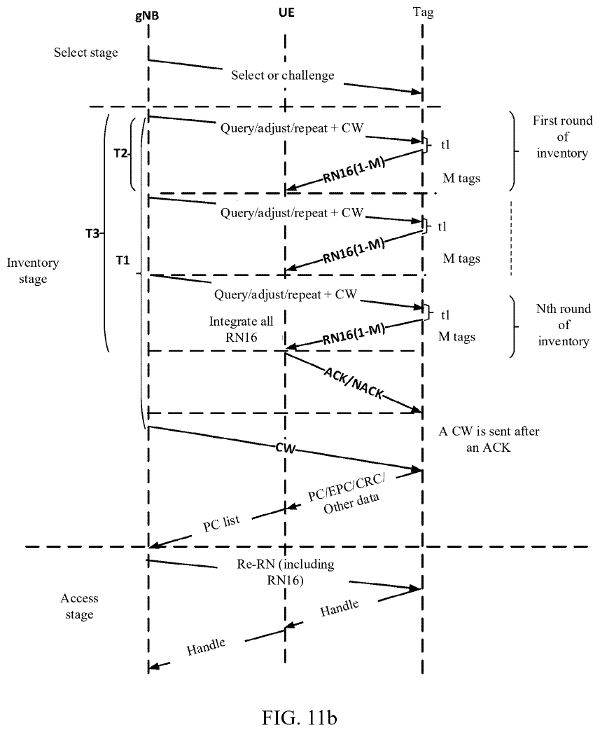

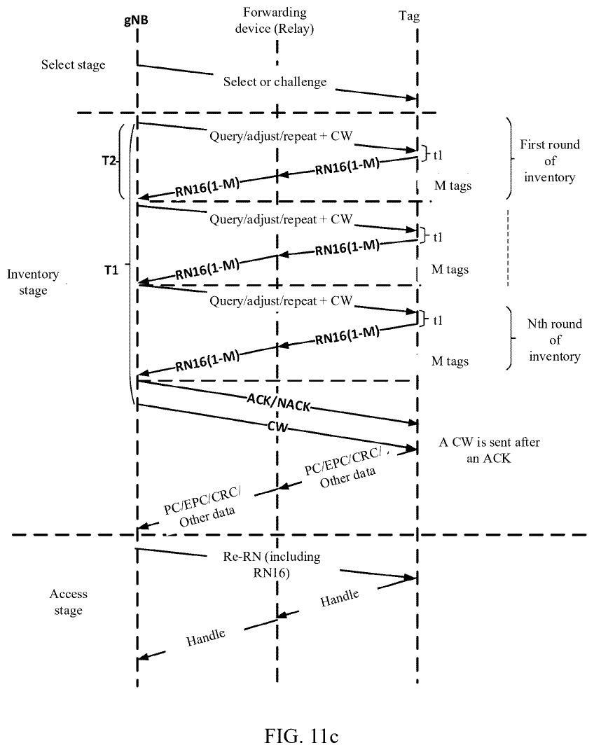

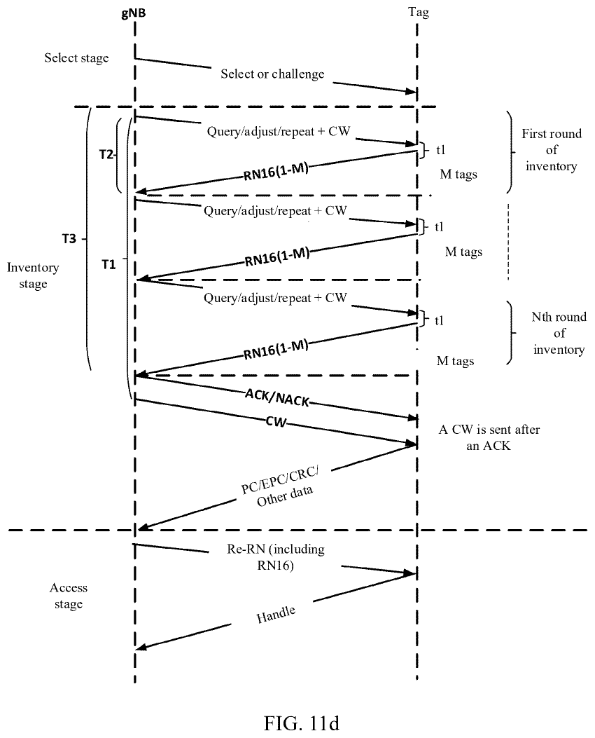

A schematic interaction diagram shown in FIG. 11a is used as an example. The first time interval is represented by T1, the second time interval is represented by T2, the third time interval is represented by T3, and the fourth time interval is represented by t1. By using the first time interval being represented by T1, the second time interval being represented by T2, the third time interval being represented by T3, and the fourth time interval being represented by t1, a time sequence of each piece of information or signal transmission node in the backscatter communication can be determined, so that a delay of the backscatter communication can be reduced.

Option 5: The target resource information may include time-frequency resource information for sending and/or receiving at least one of the first information, the command, the CW, and the feedback information. For example, if the network side device instructs the terminal to send the command, the target resource information may include resource frequency domain resource information and time domain resource information used when the terminal sends the command. Assuming that the network side device instructs the terminal to receive the feedback information of the backscatter device, the target resource information may include frequency domain resource information and time domain resource information used when the terminal receives the feedback information.

In this embodiment of this application, the network side device may send the first configuration information to the terminal and the backscatter device, so that the network side device, the terminal, and the backscatter device agree on a communication mode and a related parameter that are used for the backscatter communication; or the network side device may send the first configuration information to the terminal, and the terminal sends the third configuration information to the backscatter device based on the first configuration information, and in this case, the terminal may determine a target communication mode and a related parameter of the backscatter communication based on the first configuration information, and the backscatter device may determine a target communication mode and a related parameter of the backscatter communication based on the third configuration information. This can also enable the network side device, the terminal, and the backscatter device to agree on the communication mode and the related parameter that are used for the backscatter communication. In this way, after the network side device, the terminal, and the backscatter device agree on the communication mode and the related parameter that are used for the backscatter communication, the backscatter communication can be performed based on consistent communication modes and related parameters, thereby improving performance of the backscatter communication.

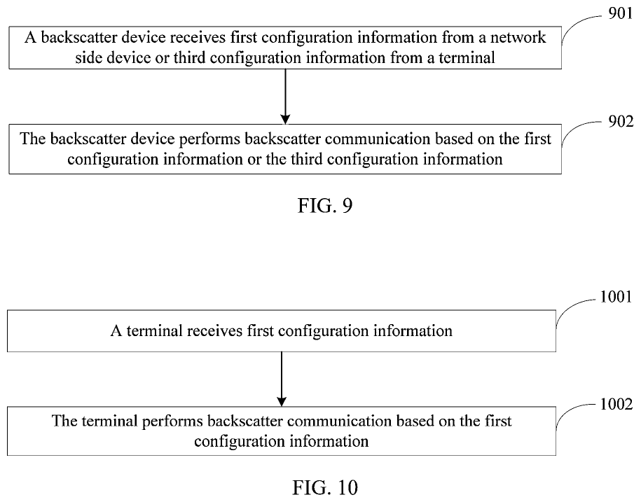

Referring to FIG. 9, FIG. 9 is a second type of backscatter communication configuration method according to an embodiment of this application. A difference between the backscatter communication configuration method shown in FIG. 9 and the backscatter communication configuration method shown in FIG. 7 lies in that the backscatter communication configuration method shown in FIG. 9 is performed by a backscatter device (for example, a tag), and the backscatter communication configuration method shown in FIG. 7 is performed by a network side device. As shown in FIG. 9, the backscatter communication configuration method performed by the backscatter device may include the following steps:

Step 901: The backscatter device receives first configuration information from a network side device, or receives third configuration information from a terminal.

Step 902: The backscatter device performs backscatter communication based on the first configuration information or the third configuration information, where the first configuration information or the third configuration information indicates a transmission parameter of the backscatter device in a target communication mode.

During implementation, the first configuration information has a same meaning and function as the first configuration information sent by the network side device in the method embodiment shown in FIG. 7. Details are not described herein again.

In addition, for the third configuration information, as in the method embodiment shown in FIG. 7, after the network side device sends the first configuration information to the terminal, the terminal determines the third configuration information based on the first configuration information and sends the third configuration information to the backscatter device. Content of the third configuration information may be the same as that of the first configuration information, or the first configuration information may be configuration information used to configure behavior of the terminal and the backscatter device, and the third configuration information may be configuration information used to configure behavior of the backscatter device. Both the first configuration information and the third configuration information can enable the backscatter device to perform backscatter communication based on the target communication mode. Details are not described herein again.

In some embodiments, the target communication mode includes either of the following:
a first mode, where in the first mode, the backscatter device performs the backscatter communication with assistance of the terminal; and
a second mode, where in the second mode, the backscatter device performs the backscatter communication without assistance of the terminal.

In some embodiments, the transmission parameter includes at least one of the following: a coding scheme, a modulation frequency, a data rate, a Q value, and feedback time of feedback information.

In some embodiments, that the backscatter device receives first configuration information from a network side device, or receives third configuration information from a terminal includes:
the backscatter device receives a first control command from the network side device or the terminal, where the first control command from the network side device includes the first configuration information, or the first control command from the terminal includes the third configuration information; and
that the backscatter device performs backscatter communication based on the first configuration information or the third configuration information includes:
the backscatter device executes the first control command based on the first configuration information or the third configuration information, and sends feedback information of executing the first control command.

During implementation, the first parameter may further indicate that a receive end of the feedback information is the network side device or the terminal, and in this case, that the backscatter device executes the first control command based on the first configuration information or the third configuration information and sends feedback information of executing the first control command may be that after executing the first control command, the backscatter device sends the feedback information to the receive end of the feedback information that is indicated by the network side device.

The second type of backscatter communication configuration method provided in this embodiment of this application corresponds to the method embodiment shown in FIG. 7, and a similar beneficial effect can be obtained. To avoid repetition, details are not described herein again.

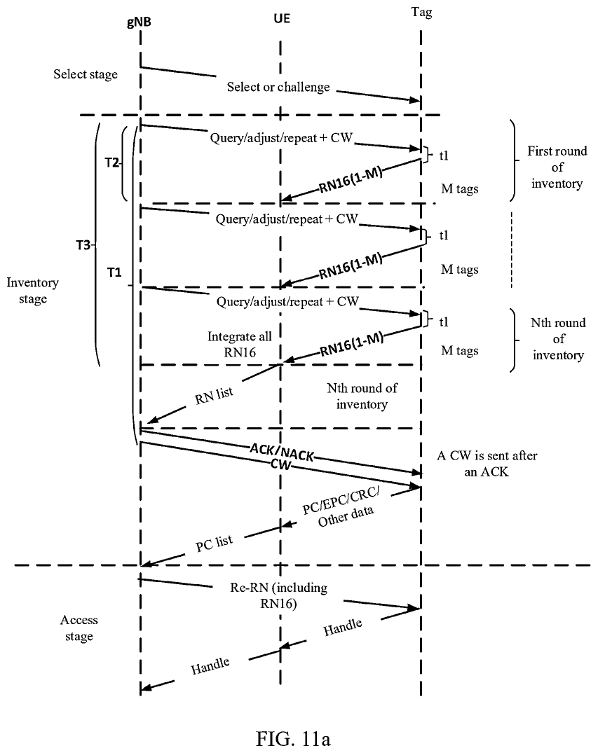

Referring to FIG. 10, FIG. 10 is a flowchart of a third type of backscatter communication configuration method according to an embodiment of this application. A difference between the method embodiment shown in FIG. 10 and the method embodiment shown in FIG. 7 lies in that the method embodiment shown in FIG. 10 is performed by a terminal and the method embodiment shown in FIG. 7 is performed by a network side device. As shown in FIG. 10, the backscatter communication configuration method performed by the terminal may include the following steps:

Step 1001: The terminal receives first configuration information, where the first configuration information is used to indicate either of the following:
a target communication mode of backscatter communication; and
the target communication mode and a first parameter, where the first parameter is a related communication parameter corresponding to the target communication mode.

Step 1002: The terminal performs backscatter communication based on the first configuration information.

In some embodiments, the target communication mode includes either of the following:
a first mode, where in the first mode, the terminal assists a network side device and a backscatter device in performing the backscatter communication; and
a second mode, where in the second mode, the terminal does not assist the network side device and the backscatter device in performing the backscatter communication.

In the first mode, that the terminal performs backscatter communication based on the first configuration information may be: the terminal assists the network side device in performing at least one of the following in the backscatter communication: sending a first signal, sending a control command, receiving feedback information, integrating and reporting feedback information, and the like.

In the second mode, that the terminal performs backscatter communication based on the first configuration information may be: the terminal forwards feedback information reflected by a tag to the network side device instead of assisting the network side device in performing the backscatter communication with the tag. In some embodiments, the terminal may not forward the feedback information of the tag to the network side device, that is, the network side device directly receives the feedback information from the tag. Details are not described herein.

In some embodiments, in a case that the target communication mode is the first mode, the method further includes:
the terminal determines third configuration information based on the first configuration information; and
the terminal sends the third configuration information to a backscatter device related to the backscatter communication, where the third configuration information is used to indicate a transmission parameter of the backscatter device in the target communication mode.

A relationship between the first configuration information and the third configuration information is the same as a relationship between the first configuration information and the third configuration information in the method embodiment shown in FIG. 9. Details are not described herein again.

In this implementation, the network side device may configure the target communication mode and the communication parameter in the target communication mode for the terminal only, and the terminal determines, based on configuration of the network side device, how to configure the transmission parameter of the backscatter device in the target communication mode.

In some embodiments, the transmission parameter includes at least one of the following:
a coding scheme, a modulation frequency, a data rate, a Q value, and feedback time of feedback information, where the Q value is used to control a response probability of the backscatter device.

In some embodiments, in a case that the target communication mode is the first mode, the first parameter includes at least one of the following:
first indication information, where the first indication information is used to indicate a transmit end of a first signal, the first signal is an excitation source of the backscatter device, and the transmit end of the first signal includes the network side device or the terminal;
second indication information, where the second indication information is used to indicate a transmit end of a control command, the control command is used to control the backscatter device, and the transmit end of the control command includes the network side device or the terminal; and
third indication information, where the third indication information is used to indicate a receive end of feedback information in the backscatter communication, the feedback information corresponds to the control command, the backscatter device obtains, based on the first signal, an excitation source that sends the feedback information, and the receive end of the feedback information includes the network side device or the terminal.

In some embodiments, the control command includes at least one of the following:
a first control command, where the first control command includes at least one of a select command, a challenge command, and an access command; and
a second control command, where the second control command is a feedback command corresponding to the feedback information.

In some embodiments, in a case that the second indication information indicates that the transmit end of the control command is the terminal, that the terminal performs backscatter communication based on the first configuration information includes:
the terminal sends the first control command to the backscatter device; and
the terminal receives feedback information from the backscatter device, or the terminal receives first information from the network side device, where the first information is feedback information of at least a part of the backscatter device.

In some embodiments, in a case that the second indication information indicates that the transmit end of the control command is the terminal and the third indication information indicates that the receive end of the feedback information is the terminal, that the terminal performs backscatter communication based on the first configuration information includes:
the terminal receives feedback information from the backscatter device, or the terminal receives first information from the network side device, where the first information is feedback information of at least a part of the backscatter device; and
the terminal sends the second control command to the backscatter device.

In some embodiments, in a case that the third indication information indicates that the receive end of the feedback information is the terminal, if a processing end of the feedback information is the network side device, the third indication information is further used to instruct the terminal to send first information to the network side device, where the first information includes feedback information of a first device that is received by the terminal, and the first device includes at least a part of the backscatter device that receives the control command; and
that the terminal performs backscatter communication based on the first configuration information includes:
the terminal receives feedback information from the first device;
the terminal determines first information based on the received feedback information; and
the terminal sends the first information to the network side device.

During implementation, in a case that the network side device instructs to perform N rounds of inventory, the first information may be information obtained after the terminal sorts all feedback information reflected by the backscatter device in the N rounds of inventory.

In some embodiments, in a case that the target communication mode is the second mode, the first parameter includes at least one of the following:
fourth indication information, where the fourth indication information is used to indicate forwarding information of the backscatter communication.

In some embodiments, the fourth indication information is used to indicate either of the following:
the network side device directly performs the backscatter communication with the backscatter device; and
the network side device performs the backscatter communication with the backscatter device by using the terminal, where the terminal is configured to forward, in the backscatter communication to the network side device, feedback information sent by the backscatter device.

In some embodiments, the feedback information includes at least one of the following:
a temporary identifier of the backscatter device, a quantity of rounds of inventory, a protocol control word PC, an extended protocol control word XPC, and an electronic product code EPC.

In some embodiments, the first parameter further includes at least one of the following:
a transmission parameter of the backscatter device, where the transmission parameter includes at least one of the following: a coding scheme, a modulation frequency, a data rate, and a Q value, and the Q value is used to control a response probability of the backscatter device;
a quantity N of rounds of inventory, where N is a positive integer;
a quantity M of backscatter devices in each round of inventory, where M is a positive integer;
a target timeline, where the target timeline includes time information of at least one signal transmission node in the backscatter communication; and
target resource information, where the target resource information includes time domain and/or frequency domain resource information of at least one transmission in the backscatter communication.

In some embodiments, the time information includes at least one of the following:
a first time interval, where a sending moment of the first signal is located in the first time interval, a start time point of the first time interval is an end moment of a first time unit, the first time unit is a time unit that sends a 1^{st} first control command to the backscatter device, and the first signal is used as an excitation source of the backscatter device;
a second time interval, where a time interval for sending two adjacent first control commands is greater than or equal to the second time interval;
a third time interval, where in a case that the target communication mode is a first communication mode, a sending moment of the first information is located in the third time interval, a start time point of the third time interval is a start/end moment of the first time unit, the first information includes feedback information of the first device, and the first device includes at least a part of the backscatter device that receives the first control command; and
a fourth time interval, where a time interval between a moment at which a same backscatter device receives the first control command and a moment at which the feedback information is sent is less than or equal to the fourth time interval.

In some embodiments, in a case that the first parameter includes the quantity N of rounds of inventory and N is greater than 1, a control command used to control the backscatter device includes an inventory round identifier, the inventory round identifier indicates that the control command is used for an n^{th} round of inventory, and n is a positive integer less than or equal to N.

A third type of backscatter communication configuration method provided in an embodiment of this application corresponds to the method embodiments shown in FIG. 7 and FIG. 9, and a similar beneficial effect can be obtained. To avoid repetition, details are not described herein again.

To facilitate description of the backscatter communication configuration method provided in this embodiment of this application, a schematic information interaction diagram shown in FIG. 11a to FIG. 11d is used as an example to describe the backscatter communication configuration method provided in this embodiment of this application.

### Embodiment 1

In an embodiment shown in FIG. 11a, a network side device (gNB) configures a UE-assisted backscatter communication scenario (that is, a target communication mode is a first mode). In this scenario, it is assumed that the network side device separately sends first configuration information to UE and a tag.

The first configuration information sent by the network side device to the UE may indicate the following information:
(1) That a control command (including a first control command and a second control command) and a CW are sent by the network side device, and sending time of each control command and each CW.
(2) N rounds of inventory are performed, where an inventory of M tags is made each time.
(3) The UE receives feedback information from the tag, integrates the feedback information to obtain first information, and reports the first information to the network side device, and transmission information used when the first information is reported is also configured by the network side device.
(4) A first time interval T1, a second time interval T2, and a third time interval T3.

For meanings of the first time interval T1, the second time interval T2, and the third time interval T3, reference may be made to explanations in the method embodiment shown in FIG. 7. Details are not described herein again.

M and N may be explicitly indicated by a network, or may be implicitly indicated by a communication model. M and N are independent of each other, and a value of M in each round of inventory may be reconfigured.

One round of inventory is used as an example. Because M tags in this round of inventory are in a contention relationship, a tag that fails in contention does not feed back RN16 information. Finally, the first information reported by the UE does not necessarily include M tags.

During implementation, the network side device may notify the UE of content in the first configuration information by using a signal such as RRC signaling, a MAC CE, and DCI.

In addition, the first configuration information sent by the network side device to the tag may indicate the following information:
a transmission parameter of the tag, including a coding scheme, a modulation frequency, a data rate, a Q value, feedback time of feedback information, and the like; and a fourth time interval t1.

The network side device may configure the content in the first configuration information of the tag by using a select command of a command.

It should be noted that in FIG. 11a, a control command and a CW are sent by the gNB. In actual application, transmission resources of the control command and the CW do not overlap in time domain, and FIG. 11a is merely an example.

In addition, in the embodiment shown in FIG. 11a, the gNB sends the control command and the CW, and the terminal receives the feedback information of the tag and reports the first information to the gNB.

In actual application, different devices (gNB or UE) may further be configured to send the command (a first control command and a second control command) and the CW, and process the feedback information of the tag, so that different communication scenarios are obtained. In addition, different timeline configurations of different communication scenarios are different, for example, the following Embodiment 2 shown in FIG. 11b.

### Embodiment 2

In an embodiment shown in FIG. 11b, a network side device (gNB) configures a UE-assisted backscatter communication scenario (that is, a target communication mode is a first mode). In this scenario, it is assumed that the network side device separately sends first configuration information to UE and a tag.

The first configuration information sent by the network side device to the UE may indicate the following information:
(1) The target communication mode is the first mode.
(2) The network side device sends a first control command and a CW.
(3) N rounds of inventory are performed, where an inventory of M tags is made each time.
(4) The UE receives feedback information from the tag, and sends a second control command (ACK/NACK) to the tag based on the feedback information.
(5) A first time interval T1, a second time interval T2, and a third time interval T3.

For meanings of the first time interval T1, the second time interval T2, and the third time interval T3, reference may be made to explanations in the method embodiment shown in FIG. 7. Details are not described herein again.

In addition, the first configuration information sent by the network side device to the tag may indicate the following information:
a transmission parameter of the tag, including a coding scheme, a modulation frequency, a data rate, a Q value, feedback time of feedback information, and the like; and
a fourth time interval t1.

In addition to an interaction processes shown in FIG. 11a and FIG. 11b, the network side device may further configure the terminal to send at least one of the first control command, the second control command, and the CW, and/or the network side device configures the network side device to receive the feedback information from the tag. Details are not described herein again.

### Embodiment 3

In an embodiment shown in FIG. 11c, a network side device (gNB) configures a non-UE-assisted backscatter communication scenario (that is, a target communication mode is a second mode). In this scenario, it is assumed that the network side device separately sends first configuration information to UE and a tag.

The first configuration information sent by the network side device may indicate the following information:
(1) The target communication mode is the second mode.
(2) There is a forwarding device (relay) (in this embodiment, it is assumed that the relay is UE, and during implementation, the relay may be a device other than the UE, which constitutes no limitation herein) that participates in backscatter communication.
(3) The network side device sends a control command and a CW.
(4) N rounds of inventory are performed, where an inventory of M tags is made each time.
(5) After receiving information about a plurality of round of inventory, the network side device performs ACK/NACK based on feedback information of the tag.
(6) A transmission parameter of the tag, including a coding scheme, a modulation frequency, a data rate, a Q value, time of the feedback information, and the like, where whether there is a relay affects feedback time of the tag, and may also affect M, N, or the transmission parameter.
(7) A first time interval T1, a second time interval T2, a third time interval T3, and a fourth time interval t1.

The forwarding device (for example, the UE) only plays a relay forwarding role on a signal, and does not play another role.

### Embodiment 4

In an embodiment shown in FIG. 11d, a network side device (gNB) configures a non-UE-assisted backscatter communication scenario (that is, a target communication mode is a second mode). In this scenario, it is assumed that the network side device sends first configuration information to a tag.

The first configuration information sent by the network side device may indicate the following information:
(1) The target communication mode is the second mode.
(2) No forwarding device participates in backscatter communication.
(3) The network side device sends a control command and a CW.
4) N rounds of inventory are performed, where an inventory of M tags is made each time.
(5) After receiving information about a plurality of round of inventory, the network side device performs ACK/NACK based on feedback information of the tag.
(6) A transmission parameter of the tag, including a coding scheme, a modulation frequency, a data rate, a Q value, time of the feedback information, and the like.
(7) A first time interval T1, a second time interval T2, a third time interval T3, and a fourth time interval t1.

The backscatter communication configuration method provided in the embodiments of this application may be performed by a backscatter communication configuration apparatus. In the embodiments of this application, that the backscatter communication configuration apparatus performs the backscatter communication configuration information is used as an example to describe the backscatter communication configuration apparatus provided in the embodiments of this application.

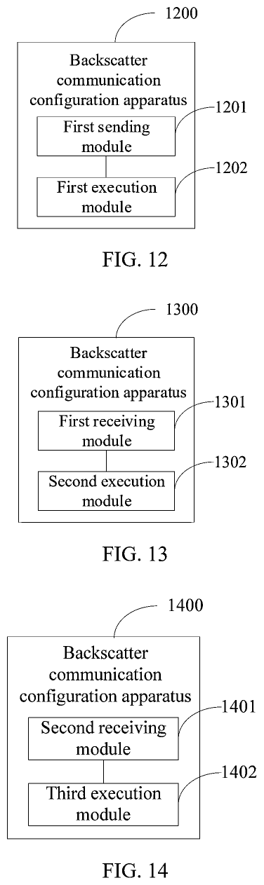

As shown in FIG. 12, a first type of backscatter communication configuration apparatus provided in this embodiment of this application may be applied to a network side device. As shown in FIG. 12, the backscatter communication configuration apparatus 1200 may include the following modules:
a first sending module 1201, configured to send first configuration information; and
a first execution module 1202, configured to perform backscatter communication based on the first configuration information; where
the first configuration information is used to indicate either of the following:
a target communication mode of the backscatter communication; and
the target communication mode and a first parameter, where the first parameter is a related communication parameter corresponding to the target communication mode.

In some embodiments, the target communication mode includes at least one of the following:
a first mode, where in the first mode, the network side device performs the backscatter communication with assistance of a terminal; and
a second mode, where in the second mode, the network side device performs the backscatter communication without assistance of the terminal.

In some embodiments, in a case that the target communication mode is the first mode, the first parameter includes at least one of the following:
first indication information, where the first indication information is used to indicate a transmit end of a first signal, the first signal is an excitation source of the backscatter device, and the transmit end of the first signal includes the network side device or the terminal;
second indication information, where the second indication information is used to indicate a transmit end of a control command, the control command is used to control the backscatter device, and the transmit end of the control command includes the network side device or the terminal; and
third indication information, where the third indication information is used to indicate a receive end of feedback information in the backscatter communication, the feedback information corresponds to the control command, the backscatter device obtains, based on the first signal, an excitation source that sends the feedback information, and the receive end of the feedback information includes the network side device or the terminal.

In some embodiments, in a case that the receive end of the feedback information that is indicated by the third indication information is different from a processing end of the feedback information, the third indication information is further used to instruct the receive end of the feedback information to send first information to the processing end of the feedback information, the first information includes feedback information of a first device that is received by the receive end of the feedback information, and the first device includes at least a part of the backscatter device that receives the control command.

In some embodiments, the first parameter further includes:
second configuration information, where the second configuration information is used to configure a first transmission parameter, and the first transmission parameter is a transmission parameter used when the network side device receives the first information.

In some embodiments, the control command includes at least one of the following:
a first control command, where the first control command includes at least one of a select command, a challenge command, and an access command; and
a second control command, where the second control command is a feedback command corresponding to the feedback information.

In some embodiments, in a case that the second indication information indicates that the transmit end of the control command is the network side device, the first execution module 1202 includes:
a first sending unit, configured to send the first control command to the backscatter device; and
a first receiving unit, configured to receive feedback information from the backscatter device, or receive first information from the terminal, where the first information is feedback information of at least a part of the backscatter device.

In some embodiments, in a case that the second indication information indicates that the transmit end of the control command is the network side device, the first execution module 1202 includes:
a second receiving unit, configured to receive feedback information from a first device, or receive first information from the terminal, where the first device includes at least a part of the backscatter device that receives the first control command, and the first information includes feedback information of the first device that is received by the terminal; and
a second sending unit, configured to send the second control command to the first device.

In some embodiments, in a case that the target communication mode is the second mode, the first parameter includes at least one of the following:
fourth indication information, where the fourth indication information is used to indicate forwarding information of the backscatter communication.

In some embodiments, the fourth indication information is used to indicate either of the following:
the network side device directly performs the backscatter communication with the backscatter device; and
the network side device performs the backscatter communication with the backscatter device by using a forwarding device.

In some embodiments, in a case that the target communication mode is the second mode, the first execution module 1202 includes:
a third sending unit, configured to send a first control command to the backscatter device, where the first control command includes at least one of a select command, a challenge command, and an access command;
a third receiving unit, configured to receive feedback information of a first device, where the first device includes at least a part of the backscatter device; and
a fourth sending unit, configured to send a second control command to the first device, where the second control command is a feedback command corresponding to the feedback information.

In some embodiments, the feedback information includes at least one of the following:
a temporary identifier of the backscatter device, a quantity of rounds of inventory, a protocol control word PC, an extended protocol control word XPC, and an electronic product code EPC.

In some embodiments, the first parameter further includes at least one of the following:
a transmission parameter of the backscatter device, where the transmission parameter includes at least one of the following: a coding scheme, a modulation frequency, a data rate, and a Q value, and the Q value is used to control a response probability of the backscatter device;
a quantity N of rounds of inventory, where N is a positive integer;
a quantity M of backscatter devices in each round of inventory, where M is a positive integer;
a target timeline, where the target timeline includes time information of at least one signal transmission node in the backscatter communication; and
target resource information, where the target resource information includes time domain and/or frequency domain resource information of at least one transmission in the backscatter communication.

In some embodiments, the time information includes at least one of the following:
a first time interval, where a sending moment of the first signal is located in the first time interval, a start time point of the first time interval is an end moment of a first time unit, the first time unit is a time unit that sends a 1^{st} first control command to the backscatter device, and the first signal is used as an excitation source of the backscatter device;
a second time interval, where a time interval for sending two adjacent first control commands is greater than or equal to the second time interval;
a third time interval, where in a case that the target communication mode is a first communication mode, a sending moment of the first information is located in the third time interval, a start time point of the third time interval is a start/end moment of the first time unit, the first information includes feedback information of the first device, and the first device includes at least a part of the backscatter device that receives the first control command; and
a fourth time interval, where a time interval between a moment at which a same backscatter device receives the first control command and a moment at which the feedback information is sent is less than or equal to the fourth time interval.

In some embodiments, in a case that the first parameter includes the quantity N of rounds of inventory and N is greater than 1, a control command for controlling the backscatter device includes an inventory round identifier, and the inventory round identifier indicates that the control command is used for an n^{th} round of inventory, and n is a positive integer less than or equal to N.

The backscatter communication configuration apparatus 1200 provided in this embodiment of this application can perform the processes performed by the network side device in the method embodiment shown in FIG. 7, and a same beneficial effect can be achieved. To avoid repetition, details are not described herein again.

As shown in FIG. 13, a second type of backscatter communication configuration apparatus provided in this embodiment of this application may be applied to a backscatter device. As shown in FIG. 13, the backscatter communication configuration apparatus 1300 may include the following modules:
a first receiving module 1301, configured to receive first configuration information from a network side device, or configured to receive third configuration information from a terminal; and
a second execution module 1302, configured to perform backscatter communication based on the first configuration information or the third configuration information; where
the first configuration information or the third configuration information indicates a transmission parameter of the backscatter device in a target communication mode.

In some embodiments, the target communication mode includes at least one of the following:
a first mode, where in the first mode, the backscatter device performs the backscatter communication with assistance of the terminal; and
a second mode, where in the second mode, the backscatter device performs the backscatter communication without assistance of the terminal.

In some embodiments, the transmission parameter includes at least one of the following: a coding scheme, a modulation frequency, a data rate, a Q value, and feedback time of feedback information.

In some embodiments, the first receiving module 1301 is configured to:
receive a first control command from the network side device or the terminal, where the first control command from the network side device includes the first configuration information, or the first control command from the terminal includes the third configuration information; and
the second execution module 1302 is configured to:
execute the first control command based on the first configuration information or the third configuration information, and send feedback information of executing the first control command.

The backscatter communication configuration apparatus 1300 provided in this embodiment of this application can perform the processes performed by the backscatter device in the method embodiment shown in FIG. 9, and a same beneficial effect can be achieved. To avoid repetition, details are not described herein again.

As shown in FIG. 14, a third type of backscatter communication configuration apparatus provided in this embodiment of this application may be applied to a terminal. As shown in FIG. 14, the backscatter communication configuration apparatus 1400 may include the following modules:
a second receiving module 1401, configured to receive first configuration information; and
a third execution module 1402, configured to perform backscatter communication based on the first configuration information; where
the first configuration information is used to indicate either of the following:
a target communication mode of the backscatter communication; and
the target communication mode and a first parameter, where the first parameter is a related communication parameter corresponding to the target communication mode.

In some embodiments, the target communication mode includes at least one of the following:
a first mode, where in the first mode, the terminal assists a network side device and a backscatter device in performing the backscatter communication; and
a second mode, where in the second mode, the terminal does not assist the network side device and the backscatter device in performing the backscatter communication.

In some embodiments, in a case that the target communication mode is the first mode, the backscatter communication configuration apparatus 1400 further includes:
a determining module, configured to determine third configuration information based on the first configuration information; and
a second sending module, configured to send the third configuration information to a backscatter device related to the backscatter communication, where the third configuration information is used to indicate a transmission parameter of the backscatter device in the target communication mode.

In some embodiments, the transmission parameter includes at least one of the following:
a coding scheme, a modulation frequency, a data rate, a Q value, and feedback time of feedback information, where the Q value is used to control a response probability of the backscatter device.

In some embodiments, in a case that the target communication mode is the first mode, the first parameter includes at least one of the following:
first indication information, where the first indication information is used to indicate a transmit end of a first signal, the first signal is an excitation source of the backscatter device, and the transmit end of the first signal includes the network side device or the terminal;
second indication information, where the second indication information is used to indicate a transmit end of a control command, the control command is used to control the backscatter device, and the transmit end of the control command includes the network side device or the terminal; and
third indication information, where the third indication information is used to indicate a receive end of feedback information in the backscatter communication, the feedback information corresponds to the control command, the backscatter device obtains, based on the first signal, an excitation source that sends the feedback information, and the receive end of the feedback information includes the network side device or the terminal.

In some embodiments, the control command includes at least one of the following:
a first control command, where the first control command includes at least one of a select command, a challenge command, and an access command; and
a second control command, where the second control command is a feedback command corresponding to the feedback information.

In some embodiments, in a case that the second indication information indicates that the transmit end of the control command is the terminal, the third execution module 1402 includes:
a fifth sending unit, configured to send the first control command to the backscatter device; and
a fifth receiving unit, configured to receive feedback information from the backscatter device, or receive, by the terminal, first information from the network side device, where the first information is feedback information of at least a part of the backscatter device.

In some embodiments, in a case that the second indication information indicates that the transmit end of the control command is the terminal and the third indication information indicates that the receive end of the feedback information is the terminal, the third execution module 1402 includes:
a sixth receiving unit, configured to feedback information from the backscatter device, or receive, by the terminal, first information from the network side device, where the first information is feedback information of at least a part of the backscatter device; and
a sixth sending unit, configured to send the second control command to the backscatter device.

In some embodiments, in a case that the third indication information indicates that the receive end of the feedback information is the terminal, if a processing end of the feedback information is the network side device, the third indication information is further used to instruct the terminal to send first information to the network side device, where the first information includes feedback information of a first device that is received by the terminal, and the first device includes at least a part of the backscatter device that receives the control command; and
the third execution module 1402 includes:
a seventh receiving unit, configured to receive feedback information from the first device;
a determining unit, configured to determine first information based on the received feedback information; and
a seventh sending unit, configured to send the first information to the network side device.

In some embodiments, the first parameter further includes:
second configuration information, where the second configuration information is used to configure a first transmission parameter, and the first transmission parameter is a transmission parameter used when the terminal sends the first information to the network side device.

In some embodiments, in a case that the target communication mode is the second mode, the first parameter includes at least one of the following:
fourth indication information, where the fourth indication information is used to indicate forwarding information of the backscatter communication.

In some embodiments, the fourth indication information is used to indicate either of the following:
the network side device directly performs the backscatter communication with the backscatter device; and
the network side device performs the backscatter communication with the backscatter device by using the terminal, where the terminal is configured to forward, in the backscatter communication to the network side device, feedback information sent by the backscatter device.

In some embodiments, the feedback information includes at least one of the following:
a temporary identifier of the backscatter device, a quantity of rounds of inventory, a protocol control word PC, an extended protocol control word XPC, and an electronic product code EPC.

In some embodiments, the first parameter further includes at least one of the following:
a transmission parameter of the backscatter device, where the transmission parameter includes at least one of the following: a coding scheme, a modulation frequency, a data rate, and a Q value, and the Q value is used to control a response probability of the backscatter device;
a quantity N of rounds of inventory, where N is a positive integer;
a quantity M of backscatter devices in each round of inventory, where M is a positive integer;
a target timeline, where the target timeline includes time information of at least one signal transmission node in the backscatter communication; and
target resource information, where the target resource information includes time domain and/or frequency domain resource information of at least one transmission in the backscatter communication.

In some embodiments, the time information includes at least one of the following:
a first time interval, where a sending moment of the first signal is located in the first time interval, a start time point of the first time interval is an end moment of a first time unit, the first time unit is a time unit that sends a 1^{st} first control command to the backscatter device, and the first signal is used as an excitation source of the backscatter device;
a second time interval, where a time interval for sending two adjacent first control commands is greater than or equal to the second time interval;
a third time interval, where in a case that the target communication mode is a first communication mode, a sending moment of the first information is located in the third time interval, a start time point of the third time interval is a start/end moment of the first time unit, the first information includes feedback information of the first device, and the first device includes at least a part of the backscatter device that receives the first control command; and
a fourth time interval, where a time interval between a moment at which a same backscatter device receives the first control command and a moment at which the feedback information is sent is less than or equal to the fourth time interval.

In some embodiments, in a case that the first parameter includes the quantity N of rounds of inventory and N is greater than 1, a control command for controlling the backscatter device includes an inventory round identifier, and the inventory round identifier indicates that the control command is used for an n^{th} round of inventory, and n is a positive integer less than or equal to N.

The backscatter communication configuration apparatus 1400 provided in this embodiment of this application can perform the processes performed by the terminal in the method embodiment shown in FIG. 10, and a same beneficial effect can be achieved. To avoid repetition, details are not described herein again.

The backscatter communication configuration apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application. The another device may be a server, a NAS, or the like.

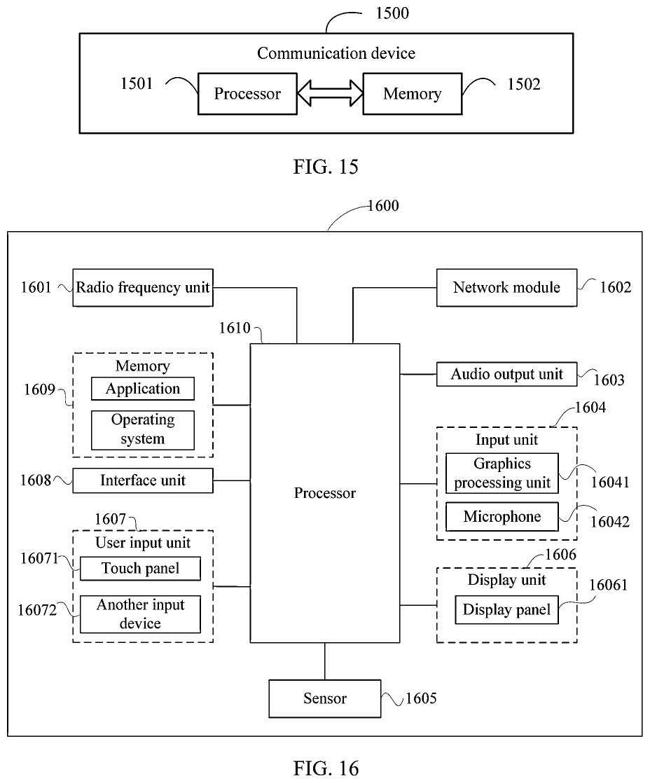

In some embodiments, as shown in FIG. 15, an embodiment of this application further provides a communication device 1500, including a processor 1501 and a memory 1502, and the memory 1502 stores a program or an instruction that is capable of being run on the processor 1501. For example, in a case that the communication device 1500 is a network side device, when the program or the instruction is executed by the processor 1501, the processes performed by the backscatter communication configuration apparatus shown in FIG. 12 are implemented, and a same technical effect can be achieved. In some embodiments, in a case that the communication device 1500 is a backscatter device, when the program or the instruction is executed by the processor 1501, the processes performed by the backscatter communication configuration apparatus shown in FIG. 13 are implemented, and a same technical effect can be achieved. In some embodiments, in a case that the communication device 1500 is a terminal, when the program or the instruction is executed by the processor 1501, the processes performed by the backscatter communication configuration apparatus shown in FIG. 14 are implemented, and a same technical effect can be achieved.

An embodiment of this application further provides a terminal, including a processor and a communication interface. The communication interface is configured to receive first configuration information and perform backscatter communication based on the first configuration information, where the first configuration information is used to indicate either of the following:
a target communication mode of the backscatter communication; and
the target communication mode and a first parameter, where the first parameter is a related communication parameter corresponding to the target communication mode.

In some embodiments, FIG. 16 is a schematic diagram of a hardware structure of a terminal according to an embodiment of this application.

The terminal 1600 includes but is not limited to at least some components in a radio frequency unit 1601, a network module 1602, an audio output unit 1603, an input unit 1604, a sensor 1605, a display unit 1606, a user input unit 1607, an interface unit 1608, a memory 1609, a processor 1610, and the like.

A person skilled in the art can understand that the terminal 1600 may further include a power supply (for example, a battery) that supplies power to each component. The power supply may be logically connected to the processor 1610 by using a power supply management system, to implement functions such as charging and discharging management, and power consumption management by using the power supply management system. The terminal structure shown in FIG. 16 constitutes no limitation on the terminal, and the terminal may include more or fewer components than those shown in the figure, or combine some components, or have different component arrangements. Details are not described herein.

It should be understood that in this embodiment of this application, the input unit 1604 may include a Graphics Processing Unit (GPU) 16041 and a microphone 16042. The graphics processing unit 16041 processes image data of a static picture or a video obtained by an image capture apparatus (for example, a camera) in a video capture mode or an image capture mode. The display unit 1606 may include a display panel 16061, and the display panel 16061 may be configured in a form of a liquid crystal display, an organic light-emitting diode, or the like. The user input unit 1607 includes at least one of a touch panel 16071 and another input device 16072. The touch panel 16071 is also referred to as a touchscreen. The touch panel 16071 may include two parts: a touch detection apparatus and a touch controller. The another input device 16072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1601 may transmit the downlink data to the processor 1610 for processing. In addition, the radio frequency unit 1601 may send uplink data to the network side device. Generally, the radio frequency unit 1601 includes but is not limited to an antenna, an amplifier, a transceiver, a coupler, a low noise amplifier, a duplexer, and the like.

The memory 1609 may be configured to store a software program or an instruction and various data. The memory 1609 may mainly include a first storage area for storing a program or an instruction and a second storage area for storing data. The first storage area may store an operating system, and an application or an instruction required by at least one function (for example, a sound playing function or an image playing function). In addition, the memory 1609 may be a volatile memory or a non-volatile memory, or the memory 1609 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1609 in this embodiment of this application includes but is not limited to these memories and any memory of another proper type.

The processor 1610 may include one or more processing units. In some embodiments, an application processor and a modem processor are integrated into the processor 1610. The application processor mainly processes an operating system, a user interface, an application, or the like. The modem processor mainly processes a wireless communication signal, for example, a baseband processor. It may be understood that, for example, the modem processor may not be integrated into the processor 1610.

The radio frequency unit 1601 is configured to: receive, by the terminal, first configuration information, and perform backscatter communication based on the first configuration information, where the first configuration information is used to indicate either of the following:
a target communication mode of the backscatter communication; and
the target communication mode and a first parameter, where the first parameter is a related communication parameter corresponding to the target communication mode.

In some embodiments, the target communication mode includes either of the following:
a first mode, where in the first mode, the terminal assists a network side device and a backscatter device in performing the backscatter communication; and
a second mode, where in the second mode, the terminal does not assist the network side device and the backscatter device in performing the backscatter communication.

In some embodiments, in a case that the target communication mode is the first mode,
the processor 1610 is configured to determine third configuration information based on the first configuration information; and
the radio frequency unit 1601 is further configured to send the third configuration information to a backscatter device related to the backscatter communication, where the third configuration information is used to indicate a transmission parameter of the backscatter device in the target communication mode.

In some embodiments, the transmission parameter includes at least one of the following:
a coding scheme, a modulation frequency, a data rate, a Q value, and feedback time of feedback information, where the Q value is used to control a response probability of the backscatter device.

In some embodiments, in a case that the target communication mode is the first mode, the first parameter includes at least one of the following:
first indication information, where the first indication information is used to indicate a transmit end of a first signal, the first signal is an excitation source of the backscatter device, and the transmit end of the first signal includes the network side device or the terminal;
second indication information, where the second indication information is used to indicate a transmit end of a control command, the control command is used to control the backscatter device, and the transmit end of the control command includes the network side device or the terminal; and
third indication information, where the third indication information is used to indicate a receive end of feedback information in the backscatter communication, the feedback information corresponds to the control command, the backscatter device obtains, based on the first signal, an excitation source that sends the feedback information, and the receive end of the feedback information includes the network side device or the terminal.

In some embodiments, the control command includes at least one of the following:
a first control command, where the first control command includes at least one of a select command, a challenge command, and an access command; and
a second control command, where the second control command is a feedback command corresponding to the feedback information.

In some embodiments, in a case that the second indication information indicates that the transmit end of the control command is the terminal, that the radio frequency unit 1601 performs backscatter communication based on the first configuration information includes:
sending the first control command to the backscatter device; and
receiving feedback information from the backscatter device, or receiving, by the terminal, first information from the network side device, where the first information is feedback information of at least a part of the backscatter device.

In some embodiments, in a case that the second indication information indicates that the transmit end of the control command is the terminal and the third indication information indicates that the receive end of the feedback information is the terminal, that the radio frequency unit 1601 performs backscatter communication based on the first configuration information includes:
receiving feedback information from the backscatter device, or receiving, by the terminal, first information from the network side device, where the first information is feedback information of at least a part of the backscatter device; and
sending the second control command to the backscatter device.

In some embodiments, in a case that the third indication information indicates that the receive end of the feedback information is the terminal, if a processing end of the feedback information is the network side device, the third indication information is further used to instruct the terminal to send first information to the network side device, where the first information includes feedback information of a first device that is received by the terminal, and the first device includes at least a part of the backscatter device that receives the control command; and
that the radio frequency unit 1601 performs backscatter communication based on the first configuration information includes:
the radio frequency unit 1601 is configured to receive feedback information from the first device;
the processor 1610 is configured to determine first information based on the received feedback information; and
the radio frequency unit 1601 is further configured to send the first information to the network side device.

In some embodiments, the first parameter further includes:
second configuration information, where the second configuration information is used to configure a first transmission parameter, and the first transmission parameter is a transmission parameter used when the terminal sends the first information to the network side device.

In some embodiments, in a case that the target communication mode is the second mode, the first parameter includes at least one of the following:
fourth indication information, where the fourth indication information is used to indicate forwarding information of the backscatter communication.

In some embodiments, the fourth indication information is used to indicate either of the following:
the network side device directly performs the backscatter communication with the backscatter device; and
the network side device performs the backscatter communication with the backscatter device by using the terminal, where the terminal is configured to forward, in the backscatter communication to the network side device, feedback information sent by the backscatter device.

In some embodiments, the feedback information includes at least one of the following:
a temporary identifier of the backscatter device, a quantity of rounds of inventory, a protocol control word PC, an extended protocol control word XPC, and an electronic product code EPC.

In some embodiments, the first parameter further includes at least one of the following:
a transmission parameter of the backscatter device, where the transmission parameter includes at least one of the following: a coding scheme, a modulation frequency, a data rate, and a Q value, and the Q value is used to control a response probability of the backscatter device;
a quantity N of rounds of inventory, where N is a positive integer;
a quantity M of backscatter devices in each round of inventory, where M is a positive integer;
a target timeline, where the target timeline includes time information of at least one signal transmission node in the backscatter communication; and
target resource information, where the target resource information includes time domain and/or frequency domain resource information of at least one transmission in the backscatter communication.

In some embodiments, the time information includes at least one of the following:
a first time interval, where a sending moment of the first signal is located in the first time interval, a start time point of the first time interval is an end moment of a first time unit, the first time unit is a time unit that sends a 1^{st} first control command to the backscatter device, and the first signal is used as an excitation source of the backscatter device;
a second time interval, where a time interval for sending two adjacent first control commands is greater than or equal to the second time interval;
a third time interval, where in a case that the target communication mode is a first communication mode, a sending moment of the first information is located in the third time interval, a start time point of the third time interval is a start/end moment of the first time unit, the first information includes feedback information of the first device, and the first device includes at least a part of the backscatter device that receives the first control command; and
a fourth time interval, where a time interval between a moment at which a same backscatter device receives the first control command and a moment at which the feedback information is sent is less than or equal to the fourth time interval.

In some embodiments, in a case that the first parameter includes the quantity N of rounds of inventory and N is greater than 1, a control command used to control the backscatter device includes an inventory round identifier, the inventory round identifier indicates that the control command is used for an n^{th} round of inventory, and n is a positive integer less than or equal to N.

The terminal 1600 provided in this embodiment of this application can perform the processes performed by the backscatter communication configuration apparatus 1400 shown in FIG. 14, and a same beneficial effect can be achieved. To avoid repetition, details are not described herein again.

An embodiment of this application further provides a network side device, including a processor and a communication interface. The communication interface is configured to send first configuration information and perform backscatter communication based on the first configuration information, where the first configuration information is used to indicate either of the following:
a target communication mode of the backscatter communication; and
the target communication mode and a first parameter, where the first parameter is a related communication parameter corresponding to the target communication mode.

This network side device embodiment is corresponding to the foregoing method embodiment of the network side device. Each implementation process and implementation of the foregoing method embodiment may be applicable to this network side device embodiment, and a same technical effect can be achieved.

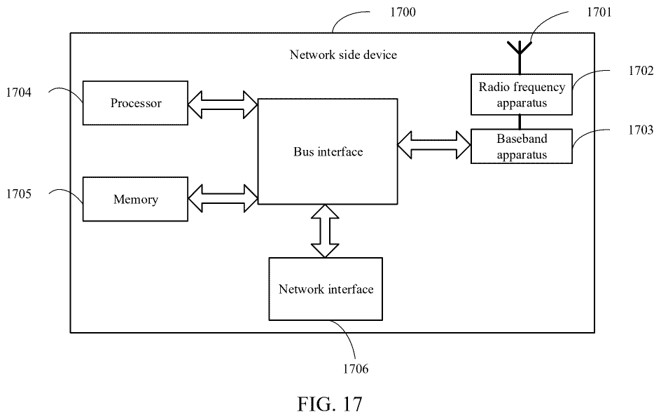

In some embodiments, an embodiment of this application further provides a network side device. As shown in FIG. 17, the network side device 1700 includes an antenna 1701, a radio frequency apparatus 1702, a baseband apparatus 1703, a processor 1704, and a memory 1705. The antenna 1701 is connected to the radio frequency apparatus 1702. In an uplink direction, the radio frequency apparatus 1702 receives information through the antenna 1701, and sends the received information to the baseband apparatus 1703 for processing. In a downlink direction, the baseband apparatus 1703 processes information that needs to be sent, and sends processed information to the radio frequency apparatus 1702. The radio frequency apparatus 1702 processes the received information, and sends processed information through the antenna 1701.

In the foregoing embodiment, the method performed by the network side device may be implemented in the baseband apparatus 1703. The baseband apparatus 1703 includes a baseband processor.

For example, the baseband apparatus 1703 may include at least one baseband board. A plurality of chips are disposed on the baseband board. As shown in FIG. 17, one chip is, for example, a baseband processor, and is connected to the memory 1705 by using a bus interface, to invoke a program in the memory 1705 to perform the operations of the network device shown in the foregoing method embodiment.

The network side device may further include a network interface 1706, and the interface is, for example, a Common Public Radio Interface (CPRI).

In some embodiments, the network side device 1700 in this embodiment of this application further includes an instruction or a program that is stored in the memory 1705 and that can run on the processor 1704. The processor 1704 invokes the instruction or the program in the memory 1705 to perform the method performed by the modules shown in FIG. 12, and a same technical effect is achieved. To avoid repetition, details are not described herein again.

An embodiment of this application further provides a readable storage medium, where the readable storage medium stores a program or an instruction, and when the program or the instruction is executed by a processor, the processes of the method embodiments shown in FIG. 7, FIG. 9, or FIG. 10 are implemented, and a same technical effect can be achieved. To avoid repetition, details are not described herein.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip, the chip includes a processor and a communication interface, the communication interface is coupled to the processor, and the processor is configured to run a program or an instruction to implement the processes of the method embodiments shown in FIG. 7, FIG. 9, or FIG. 10, and a same technical effect can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product, the computer program/program product is stored in a non-volatile storage medium, and the computer program/program product is executed by at least one processor to implement the processes of the method embodiments shown in FIG. 7, FIG. 8, or FIG. 10, and a same technical effect can be achieved. To avoid repetition, details are not described herein again.

An embodiment of this application further provides a wireless communication system, including a terminal, a network side device, and a backscatter device. The network side device may be configured to perform the steps of the method embodiment shown in FIG. 7. The backscatter device may be configured to perform the steps of the method embodiment shown in FIG. 9. The terminal may be configured to perform the steps of the method embodiment shown in FIG. 10.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A backscatter communication configuration method, comprising:
sending, by a network side device, first configuration information; and
performing, by the network side device, backscatter communication based on the first configuration information, wherein
the first configuration information is used to indicate either of the following:
a target communication mode of the backscatter communication; or
the target communication mode and a first parameter, wherein the first parameter is a communication parameter corresponding to the target communication mode.

2. The method according to claim 1, wherein the target communication mode comprises either of the following:
a first mode, wherein in the first mode, the network side device performs the backscatter communication with assistance of a terminal; or
a second mode, wherein in the second mode, the network side device performs the backscatter communication without assistance of the terminal.

3. The method according to claim 2, wherein when the target communication mode is the first mode, the first parameter comprises at least one of the following:
first indication information, wherein the first indication information is used to indicate a transmit end of a first signal, the first signal is an excitation source of the backscatter device, and the transmit end of the first signal comprises the network side device or the terminal;
second indication information, wherein the second indication information is used to indicate a transmit end of a control command, the control command is used to control the backscatter device, and the transmit end of the control command comprises the network side device or the terminal; or
third indication information, wherein the third indication information is used to indicate a receive end of feedback information in the backscatter communication, the feedback information corresponds to the control command, the backscatter device obtains, based on the first signal, an excitation source that sends the feedback information, and the receive end of the feedback information comprises the network side device or the terminal.

4. The method according to claim 3, wherein when the receive end of the feedback information that is indicated by the third indication information is different from a processing end of the feedback information, the third indication information is further used to instruct the receive end of the feedback information to send first information to the processing end of the feedback information, the first information comprises feedback information of a first device that is received by the receive end of the feedback information, and the first device comprises at least a part of the backscatter device that receives the control command.

5. The method according to claim 2, wherein when the target communication mode is the second mode, the first parameter comprises:
fourth indication information, wherein the fourth indication information is used to indicate forwarding information of the backscatter communication.

6. The method according to claim 3, wherein the feedback information comprises at least one of the following:
a temporary identifier of the backscatter device, a quantity of rounds of inventory, a protocol control word PC, an extended protocol control word (XPC), or an electronic product code (EPC).

7. The method according to claim 1, wherein the first parameter further comprises at least one of the following:
a transmission parameter of the backscatter device, wherein the transmission parameter comprises at least one of the following: a coding scheme, a modulation frequency, a data rate, or a Q value, and the Q value is used to control a response probability of the backscatter device;
a quantity N of rounds of inventory, wherein N is a positive integer;
a quantity M of backscatter devices in each round of inventory, wherein M is a positive integer;
a target timeline, wherein the target timeline comprises time information of at least one signal transmission node in the backscatter communication; or
target resource information, wherein the target resource information comprises time domain or frequency domain resource information of at least one transmission in the backscatter communication.

8. A backscatter communication configuration method, comprising:
receiving, by a backscatter device, first configuration information from a network side device or third configuration information from a terminal; and
performing, by the backscatter device, backscatter communication based on the first configuration information or the third configuration information, wherein
the first configuration information or the third configuration information indicates a transmission parameter of the backscatter device in a target communication mode.

9. The method according to claim 8, wherein the target communication mode comprises either of the following:
a first mode, wherein in the first mode, the backscatter device performs the backscatter communication with assistance of the terminal; or
a second mode, wherein in the second mode, the backscatter device performs the backscatter communication without assistance of the terminal.

10. The method according to claim 8, wherein the transmission parameter comprises at least one of the following: a coding scheme, a modulation frequency, a data rate, a Q value, or feedback time of feedback information.

11. The method according to claim 8, wherein the receiving, by the backscatter device, the first configuration information from a network side device or third configuration information from a terminal comprises:
receiving, by the backscatter device, a first control command from the network side device or the terminal, wherein the first control command from the network side device comprises the first configuration information, or the first control command from the terminal comprises the third configuration information, and
the performing, by the backscatter device, the backscatter communication based on the first configuration information or the third configuration information comprises:
executing, by the backscatter device, the first control command based on the first configuration information or the third configuration information, and sending feedback information of executing the first control command.

12. A backscatter communication configuration method, comprising:
receiving, by a terminal, first configuration information; and
performing, by the terminal, backscatter communication based on the first configuration information, wherein
the first configuration information is used to indicate either of the following:
a target communication mode of the backscatter communication; or
the target communication mode and a first parameter, wherein the first parameter is a communication parameter corresponding to the target communication mode.

13. The method according to claim 12, wherein the target communication mode comprises either of the following:
a first mode, wherein in the first mode, the terminal assists a network side device and a backscatter device in performing the backscatter communication; or
a second mode, wherein in the second mode, the terminal does not assist the network side device and the backscatter device in performing the backscatter communication.

14. The method according to claim 13, wherein when the target communication mode is the first mode, the method further comprises:
determining, by the terminal, third configuration information based on the first configuration information; and
sending, by the terminal, the third configuration information to a backscatter device related to the backscatter communication, wherein the third configuration information is used to indicate a transmission parameter of the backscatter device in the target communication mode.

15. The method according to claim 13, wherein when the target communication mode is the first mode, the first parameter comprises at least one of the following:
first indication information, wherein the first indication information is used to indicate a transmit end of a first signal, the first signal is an excitation source of the backscatter device, and the transmit end of the first signal comprises the network side device or the terminal;
second indication information, wherein the second indication information is used to indicate a transmit end of a control command, the control command is used to control the backscatter device, and the transmit end of the control command comprises the network side device or the terminal; or
third indication information, wherein the third indication information is used to indicate a receive end of feedback information in the backscatter communication, the feedback information corresponds to the control command, the backscatter device obtains, based on the first signal, an excitation source that sends the feedback information, and the receive end of the feedback information comprises the network side device or the terminal.

16. The method according to claim 15, wherein the control command comprises at least one of the following:
a first control command, wherein the first control command comprises at least one of a select command, a challenge command, or an access command; or
a second control command, wherein the second control command is a feedback command corresponding to the feedback information.

17. The method according to claim 16, wherein when the second indication information indicates that the transmit end of the control command is the terminal, the performing, by the terminal, the backscatter communication based on the first configuration information comprises:
sending, by the terminal, the first control command to the backscatter device; and
receiving, by the terminal, feedback information from the backscatter device, or receiving, by the terminal, first information from the network side device, wherein the first information is feedback information of at least a part of the backscatter device.

18. The method according to claim 16, wherein when the second indication information indicates that the transmit end of the control command is the terminal and the third indication information indicates that the receive end of the feedback information is the terminal, the performing, by the terminal, the backscatter communication based on the first configuration information comprises:
receiving, by the terminal, feedback information from the backscatter device, or receiving, by the terminal, first information from the network side device, wherein the first information is feedback information of at least a part of the backscatter device; and
sending, by the terminal, the second control command to the backscatter device.

19. The method according to claim 16, wherein when the third indication information indicates that the receive end of the feedback information is the terminal, in response to a processing end of the feedback information being the network side device, the third indication information is further used to instruct the terminal to send first information to the network side device, the first information comprises feedback information of a first device that is received by the terminal, and the first device comprises at least a part of the backscatter device that receives the control command, and
the performing, by the terminal, the backscatter communication based on the first configuration information comprises:
receiving, by the terminal, feedback information from the first device;
determining, by the terminal, first information based on the received feedback information; and
sending, by the terminal, the first information to the network side device.

20. The method according to claim 12, wherein the first parameter further comprises at least one of the following:
a transmission parameter of the backscatter device, wherein the transmission parameter comprises at least one of the following: a coding scheme, a modulation frequency, a data rate, or a Q value, and the Q value is used to control a response probability of the backscatter device;
a quantity N of rounds of inventory, wherein N is a positive integer;
a quantity M of backscatter devices in each round of inventory, wherein M is a positive integer;
a target timeline, wherein the target timeline comprises time information of at least one signal transmission node in the backscatter communication; or
target resource information, wherein the target resource information comprises time domain or frequency domain resource information of at least one transmission in the backscatter communication.
